(19) United States
(12) Patent Application Publication
(10) Pub. No.: US 2025/0065310 A1
(43) Pub. Date: Feb. 27, 2025

(54) FISCHER TROPSCH CATALYST SYSTEM

(71) Applicant: NEXCERIS INNOVATION HOLDINGS, LLC, Lewis Center, OH (US)

(72) Inventors: Matthew M. SEABAUGH, Columbus, OH (US); Sergio A. IBANEZ, Galena, OH (US); Cody J. LOCKHART, Columbus, OH (US); Anna Lee TONKOVICH, Gilbert, AZ (US); Yong WANG, Richland, WA (US)

(21) Appl. No.: 18/726,059

(22) PCT Filed: Dec. 29, 2022
(86) PCT No.: PCT/US2022/054299

§ 371 Date: Jul. 1, 2024

Related U.S. Application Data
(60) Provisional application No. 63/294,844, filed on Dec. 30, 2021.

(51) Int. Cl. B01J 23/889; B01J 21/04; B01J 21/06; B01J 21/18; B01J 23/75; B01J 35/00; B01J 35/30; B01J 35/60; B01J 37/02; B05D 1/12

(52) U.S. Cl. CPC B01J 23/8896; B01J 21/04; B01J 21/06; B01J 21/18; B01J 23/75; B01J 35/19; B01J 35/395; B01J 35/397; B01J 35/60; B01J 37/0215; B05D 1/12

(57) ABSTRACT

A novel Fischer Tropsch (FT) catalyst that has improved thermal characteristics and a highly active surface catalyst coating on a pellet to produce high quality hydrocarbon liquids and waxes even at high reactor temperatures. The catalyst shows a surprising increase in hydrocarbons and wax formation at high temperature and a much higher specific catalyst activity than demonstrated to date. More generally, a catalyst support, method of making a catalyst, and methods of FT synthesis are described.

### RELATED APPLICATIONS

This application claims the priority benefit of U.S. Provisional Patent Application Ser. No. 63/294,844 filed 30 Dec. 2021.

### GOVERNMENT RIGHTS

This invention was made with Government support under contracts DE-SC0015800 and DE-SC0013114 awarded by the U.S. Department of Energy. The Government has certain rights in this invention.

### INTRODUCTION

Fischer Tropsch (FT) chemistry emerged in the 1930's to produce synthetic transportation fuels from syngas, as derived primarily from coal. Today, the world is experiencing a need for reduced to zero carbon fuels. The low carbon synthesis gas or syngas feedstock for FT comprising carbon monoxide (CO) and hydrogen (H₂) can be derived from regenerative non-fossil biomass sources converted by pyrolysis, gasification, or other technologies, from electrolysis driven conversion of water to make hydrogen and/or carbon dioxide reduction to make CO and oxygen, or from biogas or natural gas conversion to syngas processes comprising partial oxidation, steam reforming, or autothermal reforming.

Fischer-Tropsch is a highly exothermic reaction—without heat management the reaction must be operated with reduced productivity and lower temperatures to avoid thermal runaway. These compromised conditions are chosen to favor the production of preferred liquid hydrocarbons (like naphtha, diesel, or jet fuel) and wax while reducing the production of the unwanted by-product of methane, CO2, and light hydrocarbon gases. Advanced reactor designs have been developed to attempt to address thermal management issues; these include compact microchannel reactors, structured catalysts, and the “CANS” reactor design which accommodates small conversion steps in stacked radial flow reactor CANS with intervening heat removal between serial-flow CANS as developed by Davy/Johnson Matthey.

Large scale FT reactors are based on slurry bed or fixed bed reactors which operate in a narrow operating window to control heat and avoid runaway. While the slurry bed has improved thermal characteristics, it must be configured at a large scale to achieve useful economics for implementation. The least complex and lowest cost reactor hardware concept is a simple multi-tubular fixed bed reactor. This least complex reactor is limited by heat transfer in a poorly conductive packed bed thereby leading to low reactor and catalyst productivity.

### SUMMARY OF THE INVENTION

In a first aspect, the invention provides a catalyst support, comprising three distinct layers (observable by SEM and EDS analysis), and comprising: (1) a core comprising Al, Si, C, and O; a first layer adjacent to the core, comprising Al and Si, C, and O; a second layer adjacent the first layer comprising Al, Si, C, and O; and wherein the first layer has greater porosity than the second layer and wherein the concentration of O in the core is at least 2.5 wt % less O than the first layer; or (2) a core comprising Si, C, Al, and O, and comprising at least 2 vol % of a metallic Al alloy; a first layer adjacent the core comprising Si, C, Al, and O, and comprising no more than 1 vol % of a metallic phase (preferably no discernable metallic phase); a second layer adjacent the first layer comprising Si, C, Al, and O and comprising no more than 1 vol % of a metallic phase (preferably no discernable metallic phase); and wherein the first layer has greater porosity than the second layer and wherein the concentration of O in the core is at least 2.5 wt % less O than the first layer. These weight ratios of Al, Si, C, and O can be viewed from the SEM/EDS including the presence or absence of a metallic phase.

The invention, in any of its aspects, can be further characterized by one or any combination of the following features: the core and each layer comprise from 10 to 50 wt % of each of Al, Si, C and O; the core comprises 32 to 41 wt % Al, 30 to 39 wt % Si, 3 to 13 wt % C, and 24 to 34 wt % O; the first layer comprises 26 to 34 wt % Al, 25 to 33 wt % Si, 3 to 13 wt % C, and 37 to 45 wt % O; the second layer comprises 25 to 36 wt % Al, 25 to 34 wt % Si 3 to 13 wt % C, and 36 to 44 wt % O; defined according to these ratios (core: first layer: second layer) or wherein the first layer comprises 28 to 32 wt % Al, 27 to 31 wt % Si, 3 to 13 wt % C, and 39 to 43wt % O; the second layer comprises 27 to 34 wt % Al, 27 to 32 wt % Si 3 to 13 wt % C, and 38 to 42 wt % O, or, alternatively defined according to these ranges wherein the core is 32.4% Al, to 30.6% Si, to 11.3% C, and to 25.7% O; the core first layer 27.0% Al, to 26.2% Si, to 9.7% C, and to 37.1% O; the core second layer 27.5% Al, to 26.7% Si, to 9.9% C, and to 36.0% O; wherein the catalyst support further comprises an outer protective layer of Al and O disposed outside the second layer; wherein the protective alumina layer is at least 20% more porous than the second layer of the core; a Fischer-Tropsch catalyst comprising a support (described herein) and wherein Co metal particles dispersed on an oxide powder are disposed on a layer deposited on the outer protective layer of Al and O (this structure can be obtained by depositing the Co catalyst layer as a slurry over the outer protective layer); the first layer is 100 to 1000 micrometers (μm) thick, or 250 to 750 μm thick; the second layer is 500 to 2000 μm thick, or 1000 to 1500 μm thick; the protective layer is 25 to 150 μm thick, or 50 to 100 μm thick; the catalyst layer is about 5 to 200 μm thick, or 10 to 100 μm thick; wherein an outer layer of aluminum is spray coated on the exterior of the support, which can be subsequently oxidized to produce an alumina layer; wherein the core, first layer and second layer cach comprise SiC and Al₂O₃; wherein the catalyst support is characterizable by an expansion during thermal processing of 1.0% or less (or 0.50% or less or 0.25% or less) when measured according to the conditions corresponding to the data in Table 1.6.2.

The support and/or catalyst may be further defined by any of the descriptions provided herein such as composition and/or physical properties. For example, the support or catalyst can be defined as characterizable by any of the properties or within ±30% or ±20% or ±10% of any of the properties described herein (including any properties measurable from the SEM photomicrographs) which may include the conditions of measurement as described herein. The invention also includes systems comprising the support or catalyst including apparatus and/or any selected reaction conditions such as reactants, temperatures, and/or pressures (again, these could be defined as ±30% or ±20% or ±10% of any of the conditions). For example, the catalyst support can be characterizable by possessing ±20% of one or any combination of the pore properties listed from Case 2 in Table 1.6.3.

In another aspect, the invention provides a method of conducting a Fischer-Tropsch reaction, comprising: passing a gaseous mixture of CO and H₂ over a thermally-conductive pellet catalyst at a temperature of at least 200° C.; wherein the thermally conductive catalyst comprises Co metal disposed on the outside of a catalyst pellet comprising a core comprising Al, Si, C and O having a first porosity and an outer protective alloy-derived coating layer surrounding and adjacent to the core; wherein the alloy-derived coating has a higher porosity than the core; wherein the alloy-derived coating is disposed between the core and the Co metal.

The invention, in any of its aspects, can be further characterized by one or any combination of the following features: wherein the thermally-conductive catalyst comprises a packed bed of pellets disposed in a reactor having an inner diameter of at least 0.7 cm, preferably at least 5 cm; wherein the Co metal comprises Co and (or) Re; wherein the gaseous mixture travels downward with respect to gravity through the particle bed; comprising an outer catalyst layer comprising the Co metal in the form of metal particles disposed on a porous alumina layer wherein the outer catalyst layer has a thickness of between 10 and 200 μm or between 20 and 50 μm; wherein the core and alloy coating layer define a core pellet and wherein the core pellet has a thermal conductivity between 2 and 50 W/m—K or between 5 and 20 W/m—K; wherein the temperature has a high temperature is in the range of 210 to 280° C., or 240 to 280, or 260 to 280; wherein the feed ratio of H₂:CO is in the range of 1:2 to 3:1 or 1.6 to 2.0; wherein the gaseous mixture is pretreated to remove sulfur and/or ammonia to ≤1 ppm; wherein the partial pressure of steam in a reacting mixture is maintained at 6 barg or less; wherein pressure in the reactor is in the range of 10 to 40 barg, or at least 20 barg; wherein the reaction is run 500 h without regeneration; wherein the catalyst is regenerated with hydrogen every 1000 or 2000 h or more during reaction; wherein the reaction is run at 240° C. or higher and wax is produced along with other hydrocarbons that are liquid at ambient conditions; wherein methane selectivity is 15% or less or 10% or less.

In another aspect, the invention provides a pellet comprising central region comprising the 10 wt % of the pellet that is furthest from a surface and comprises aluminum oxide, aluminum alloy and SiC, and an outer alumina region comprising 10 wt % of the pellet corresponding to the volume of the pellet that is furthest from the central region; and wherein the outer alumina region comprises aluminum oxide, SiC; and wherein the outer alumina region comprises at least 5% higher oxygen concentration as compared to the central region of the pellet. Oxygen concentration is preferably measured by Electron Dispersive X-Ray Spectroscopy. The pellet may comprise the catalyst support of any of inventive aspects; or any of the inventive aspects except not having distinct layers (for example, the layers being defined by selected distances from a central region; or a pellet having a continuous or stepped gradient with the layers being defined by selected distances from a central region). In some embodiments, the central and outer alumina regions define part of a catalyst support and further comprise a catalyst layer disposed on an exterior of the pellet.

The inventive system may comprise a Fischer Tropsch catalyst, including a feed composition comprising carbon monoxide and hydrogen. The invention includes methods of Fischer Tropsch using catalysts described herein.

In a further aspect, the invention includes a method of making a catalyst, comprising: providing a catalyst core of the type described herein; and coating the core with a slurry comprising: Co and/or Re; an organic binder, and a plasticizer. Preferably, the organic binder is selected from the group consisting of: polyvinyl alcohol, methyl cellulose, ethyl cellulose, starch, gums, polyvinyl butyral, and combinations thereof. Preferably, the plasticizer is selected from the group consisting of: glycerol, glycerin, ethylene glycol, polyethylene glycol, and combinations thereof.

In another aspect, the invention provides a pellet composition comprising a central region comprising the 10 wt % of the pellet that is furthest from a surface and comprises aluminum oxide, aluminum alloy and SiC, and an outer alumina region comprising 10 wt % of the pellet corresponding to the volume of the pellet that is furthest from the central region; and wherein the outer alumina region comprises aluminum oxide, SiC; and wherein the outer alumina region comprises at least 5% higher oxygen concentration as compared to the central region.

Preferably, the central and outer alumina regions define part of a catalyst support and further comprising a catalyst layer disposed on an exterior of the pellet. The pellet composition may comprise a FT synthesis catalyst coating and characterizable by a conversion of at least 5, or at least 10, or at least 12, or at least 15 g of CO converted per gram of catalyst per hour with a methane selectivity ≤15%, ≤10%, ≤8%, or ≤6%; wherein the characterization is conducted using catalyst pellets packed in a tube with about 3 average pellet diameters per tube inner diameter and a total of about 1 gram of active catalyst, heating to 240° C. and passing H₂ and CO in a molar ratio of 2:1 through the catalyst at a rate set to a CO conversion of between 60 and 80% as described in the activity testing of Example 20. The pellet composition may comprise a FT synthesis catalyst coating and characterizable by an alpha greater than 0.8, preferably greater than 0.84 and more preferably from 0.85 to 0.95; wherein the characterization is conducted using catalyst pellets packed in a tube with about 3 average pellet diameters per tube inner diameter and a total of about 1 gram of active catalyst, heating to 240° C. and passing H₂ and CO in a molar ratio of 2:1 through the catalyst at a rate set to a CO conversion of between 60 and 80% as described in the activity testing of Example 20. The pellet can have a hydraulic diameter from about 1 to 10 mm.

The invention also includes a catalyst or an FT method characterizable by a CO conversion of >2 g CO/g_{cat}/h or between 5 and 30 g/g_{cat}/h; and/or an alpha>0.8 at a reaction temperature of 240° C. or greater. In addition to the FT reaction, the invention is applicable to other highly thermic reactions including the exothermic production of methanol, dimethyl ether, the oxidation of ethylene, the endothermic steam reforming reaction, dry reforming reaction, or others.

Inventive concepts include any of the supports, catalysts, intermediates, methods of synthesis, methods of conducting reactions such as the FT reaction, and/or systems (which may be defined to include a combination of compositions, conditions, and/or apparatus) described herein.

Various aspects of the invention are described using the term “comprising;” however, in narrower embodiments, the invention may alternatively be described using the terms “consisting essentially of” or, more narrowly, “consisting of.”

### GLOSSARY

“Active catalyst” means a catalyst comprising a metal disposed on/within a high surface area support that is considered part of the active catalyst system and is applied as a thin coating on a substantially dense thermally conductive pellet. The active catalyst thickness ranges from about 2 to 200 microns with a preferred average thickness between about 10 and 100 microns. For activity calculations based on grams of catalyst, the entire coating including metal and high surface area support are considered as the active catalyst excluding the weight of the underlying pellet.

A “pellet” is defined as a compact of solid particles, (metallic, ceramic or organic) that is typically produced by a process of granulation and uniaxial or isostatic compression. The geometry of the compact can vary widely to meet the need of the reactor design. The term can also be used for the same compact that has been heat treated to volatilize the organic material and form a bonded structure of the remaining particles. Preferably, the thermal conductivity of the pellet is greater than about 2 W/m-K.

Throughout this description, an Al—Si alloy refers generally to an alloy comprising at least about 5% Si, typically in the range of about 7 to about 15% Si, preferably 10-14%. Throughout the specification, “%” related to materials composition refers to mass % unless otherwise specified (wt % is the same as mass %).

Hydraulic diameter is defined as the 4 times the cross-sectional area divided by the perimeter.

### BRIEF DESCRIPTION OF THE DRAWINGS

FIG. 1: SEM/EDS Images of Case 1 samples heat treated to 1400° C.; (top left) Full Pellet Cross Section SEM; (bottom left) Region A of Core—Coating Interface; (bottom right) Region B of Core-Coating Interface.

FIG. 2: SEM/EDS Images of Case 2 with Protective Coating Fired Using the Described Process Conditions; (top left) Full Pellet Cross Section SEM; (top right) Center (Region 1) of Pellet Cross Sectional SEM; (bottom left) Mid-Section (Region 2) of Pellet Cross Sectional SEM; (bottom right) Region 3 of Core-Coating Interface.

FIG. 3: Composition of O, Al, and Si at pellet exterior, mid-point, and center.

FIG. 4: Pellet change by two methods of synthesis (Case 1 and 2).

FIG. 5: Process description for making a FT coated catalyst.

FIG. 6: Pellets packed in a tubular quartz reactor.

FIG. 7: Stepwise description of steps to activate and prepare the catalyst for operation.

FIG. 8: Comparison of catalytic performance for powder Co/Re/Al₂O₃ and Co/Re/Al₂O₃ coated pellet catalysts (conditions: T=195° C., P=20 barg, H₂:CO=2:1, total flow is 30 cm³ min⁻¹).

FIG. 9: CO conversion rate and product selectivity as a function of temperature over Co/Re/Al₂O₃ coated pellet (left) and powder Co/Re/Al₂O₃ (right) catalysts. Operation conditions: P=20 barg, H₂:CO=2:1.

FIG. 10. Effect of H₂/CO ratio on catalytic performance over Co/Re/Al₂O₃ coated pellet catalyst. Operation conditions: T=225° C., P=20 barg.

FIG. 11. Selectivity/CO conversion rate vs. temperature on Co/Re/Al₂O₃ coated pellet catalyst. Operation conditions: P=20 barg, H₂:CO=1.8:1.

FIG. 12. Selectivity/CO conversion rate vs. temperature on Co/Re/Al₂O₃ coated pellet catalyst. Operation conditions: P=20 barg, H₂/CO=1.6-1.65:1.

FIG. 13. Selectivity/CO conversion rate vs. H₂/CO ratio on Co/Re/Al₂O₃ coated pellet catalyst. Operation conditions: T=255° C., P=20 barg.

FIG. 14. Carbon number distribution as collected by high temperature distillation for exemplar catalyst pellets operated from 240 to 255° C. with H₂/CO feed ratio between 1 and 1.8 with inset values of alpha shown for the three test conditions.

FIG. 15. Catalytic performance of Co/Re/Al₂O₃ coated pellet catalyst at time-on-stream of 259 h and 665 h. Reaction conditions: T=225° C., P=20 barg, H₂/CO=2:1, flow rate=30 ml/min.

FIG. 16. XRD analysis of spent powder and pellet FT catalysts.

FIG. 17. Raman analysis of fresh and spent powder and pellet FT catalysts as tested in the preceding examples.

FIG. 18: a) SEM of fresh Co/Re/Al₂O₃ coated pellet catalyst and b) SEM of spent pellet catalyst. There is no obvious flaking or delamination of the FT catalyst coating layer.

FIG. 19. Graph of the transient temperature rise within the catalyst pellet with an average catalyst thickness of about 20 μm under the FT conditions at a catalyst productivity of 19.7 g CO converted per g_{cat} per hour.

FIG. 20: Graph of the transient temperature rise within a porous interfacial layer (porosity equal to 0.4) as compared to a higher density interfacial or interlayer (porosity equal to 0.1) for the base case with an average catalyst thickness of about 50 μm.

FIG. 21: Graph of the transient temperature rise within a 300 μm diameter spherical pellet with an estimated internal porosity equal to 0.35 with an alumina-based pellet for a high catalyst productivity of 19.7 g/g/h (solid line) compared to a lower catalyst productivity of 2 g/g/h (dotted).

FIG. 22. SEM of catalyst-coated pellets using Methods #1 (A) and Method #2 (B).

FIG. 23. Product selectivity data (paraffins exclude CH₄) and total alpha value (C₂-C₁₂) on catalyst-coated pellets obtained from Method #1 (A) and Method #2 (B), respectively. Test conditions: flow rates: 10 sccm/min H₂ and 5 sccm/min CO, 20 barg.

FIG. 24 shows the FT synthesis liquid volume fraction based on the exemplar FT synthesis product composition with alpha=0.8 versus pressure in barg for temperatures between 215 and 240° C.

FIG. 25 shows the FT synthesis liquid volume fraction based on the exemplar FT synthesis product composition with alpha=0.825 versus pressure in barg for temperatures between 215 and 255° C.

FIG. 26 shows the FT synthesis liquid volume fraction based on the exemplar FT synthesis product composition with alpha=0.85 versus pressure in barg for temperatures between 215 and 265° C.

FIG. 27 shows the FT synthesis liquid volume fraction based on the exemplar FT synthesis product composition at 215° C. versus pressure in barg for alpha between 0.8 and 0.85.

### DETAILED DESCRIPTION OF THE INVENTION

The inventive pellet catalyst structure comprises a highly thermally conductive and substantially dense core (less than 35% porosity) that is overcoated with a thin layer of an active catalyst and contains an intervening thin interfacial or protective layer having a higher porosity than the core but is substantially impermeable. The core comprises SiC and aluminum oxide. The interfacial (or protective) layer is comprised of aluminum oxide. By “substantially impermeable”, we mean that, where the core comprises metallic Al and SiC, the amount of metallic Al and SiC in the core changes by less than 1% when heat treated at 1400° C. in air for 3 h. As packed in a tubular reactor or other configuration, the catalyst structure enables an effective bed thermal conductivity higher than conventional catalyst pellets, and thereby improves reactor thermal control.

The inventive technology has multiple applications to produce synthetic fuels and wax, including use in combination with electrolysis technology to produce synthesis gas from CO₂ and water to produce low to negative carbon intensity fuels and materials as compared to fossil derived feedstocks. Carbon dioxide may be captured from atmospheric gas with technologies such as amine scrubbers, Direct Air Capture (DAC), membranes and others. Alternatively, CO₂ may be captured from other industrial processes such as the bio-based production of ethanol that emits roughly half the incoming carbon as CO₂. In this case, the CO₂ is naturally concentrated above atmospheric to reduce gathering costs as associated with DAC or similar technology. Syngas should be substantially clean or contain trace levels (about <1 ppm) of sulfur, halide and/or nitrogen-based contaminants. Process unit operations may be required to clean up syngas or feed gas prior to forming synthesis gas. FT catalysts, especially cobalt based active materials, are particularly susceptible to these poisons and clean CO₂ feedstock as co-produced during fermentation to produce ethanol or other carbonaceous products is particularly advantageous to combine with SOEC electrolysis to produce CO for combination with hydrogen using the inventive FT catalyst.

Alternatively, the source of syngas may be derived from biogas or flare gas which comprises both CO₂ and CH₄. Biogas is produced as a by-product of anaerobic digestion such as that used to clean wastewater, reduce animal waste including bovine, porcine, and others, or waste food or biomass conversion. In one embodiment, the CO₂ partially converts to CO as limited by kinetics and thermodynamics using electrolysis technology or a thermochemical reactor such as Reverse Water Gas Shift (RWGS) before subsequent conversion of syngas to hydrocarbon liquids and waxes over the inventive FT catalyst. In one embodiment the methane fraction of the biogas is converted to syngas using partial oxidation, steam reforming, autothermal reforming or dry reforming (DRM) with CO₂.

In an alternate embodiment, natural gas may be used as a feedstock to produce synthesis gas for conversion over the inventive FT catalyst. The gas mixture is preferably maintained with a partial pressure of steam less than about 6 barg to reduce the FT catalyst deactivation rate. Steam may be present in the feed mixture and is co-produced with hydrocarbons during the FT reaction due to the reaction stoichiometry. In one embodiment an advantaged process may include a DRM process to produce syngas as operated with a Steam to Carbon ratio below 3 and more preferably below 2 or 1.5 or 1.2 to minimize remaining steam in the syngas mixture and or favor the conversion of CO₂ to synthesis gas. The DRM may operate at a higher pressure than the FT reactor and supply the FT feed syngas with an intervening heat exchanger to reduce temperature from a higher temperature DRM to a lower temperature FT reaction. In one embodiment, the syngas producing reactor operates at a pressure from about 10.5 to 22 barg and the FT reactor operates at a pressure from about 10 to about 21 barg. Interstage heat exchange and gas separation may be included.

The invention includes, but is not limited to FT processes in which the FT synthesis inlet stream comprises a syngas blend obtained by electrolysis of water and CO obtained by reverse-water-gas-shift reaction of hydrogen and CO₂; or in which the FT synthesis inlet stream is a syngas blend obtained by the electrolysis of water and CO₂; or in which the FT synthesis inlet stream is syngas derived from the upgrading and reforming of biomethane from anaerobic digesters, landfills, or waste water treatment facilities or in which the FT synthesis inlet stream is syngas derived from the electrolysis or reverse water gas shift reaction of previously sequestered CO₂ from fossil fuel combustion, biological fermentation processes, or direct air capture processes.

The catalyst support (core) can have (but is not limited to) a BJH adsorption pore arca and/or BJH desorption pore arca of 0.09 to 0.17 or 0.10 to 0.15 or 012-0.14 m²/g. In some preferred embodiments, the catalyst support has a BET surface area of 0.1 to 0.3 or 0.15 to 0.25 or 0.17 to 0.23 m²/g. The thermal conductivity of the core, as measured using ASTM E1461, is preferably in the range of 8 to 20 W/m—K, or 9 to 17 W/m—K at 400° C.

The invention is not limited to the amounts of coarse and fine SiC fractions used in the examples. The volume percent of coarse SiC in the mixed SiC powders preferably vary between 50% and 100% while that of fine SiC from about 0% and 50%. Preferably, coarse SiC may be chosen from SiC with grit sizes of 230 (about 70 μm in average diameter) to 600 (about 30 μm in average diameter), while fine SiC may be chosen from SiC with grit sizes of 600 (about 30 μm in average diameter) to 1200 (about 15 μm in average diameter).

For the Al—Si alloy powder, a cutectic alloy (11-13% Si) can be used, with a range of particle sizes, such as a median particle size of 2 to 50 μm. Specific examples include the S-2, S-5, S-8, S-10, S-15, S-20, and S-25 grades of Al—Si eutectic alloy 4047 powder from Valimet, Inc. Other Al—Si alloys can be used, such as those having up to about 25% of Si (on a molar basis). The volume of Al—Si (or Al, when an alloy is not used) in the mixture can be varied between about 2.5% and about 80% of the volume of SiC, between about 5% and about 50% of the volume of SiC, between about 5% and about 30% of the volume of SiC between about 10% and about 30% of the volume of SiC, or between about 10% and about 25% of the volume of SiC. When others oxide-forming metals are used in place of, or in addition to, Al or Al—Si alloy, similar total amounts of oxide-forming metals in the mixture are employed (e.g., 2.5-80% of the volume of SiC, 5-50% of the volume of SiC, 5-30% of the volume of SiC, 10-30% of the volume of SiC, or 10-25% of the volume of SiC).

Preferably, the volume of the combined PVB and BBP is between 1% and 15% (based on the total formulation prior to pellet formation), while the weight percentages of stearic acid and carbon may each be varied between about 0% and 15%. The volume ratio of BBP to PVB is preferably between about 0% and 50%. Variations are shown in Table 1 wherein the amounts of SiC and Al—Si are reported as a volume % of the total amounts of SiC and Al—Si powders, and the amounts of PVP, BBP, stearic acid and carbon are similarly reported as a % of SiC and Al—Si powders.

TABLE 1

| | |
|---|---|
| Components | Amount (range) |

| SiC (vol. %) | | 55 | 97.5 |
|---|---|---|---|
| Coarse SiC | Grit | 230 | 600 |
| | Vol. % | 47.5 | 97.5 |
| Fine SiC | Grit | 600 | 1200 |
| | Vol. % | 0 | 50 |
| Al—Si | Size (μm) | 2 | 25 |
| | Vol. % | 2.5 | 45 |

| | | |
|---|---|---|
| PVP + BBP (vol. %) | 0 | 15 |
| BBP/PVP (vol. %) | 0 | 0.5 |
| Stearic acid (wt. %) | 0 | 15 |
| Carbon (wt. %) | 0 | 15 |

Another preferred composition is shown in Table 2, wherein the amounts of SiC, Al₂O₃, and Al—Si are reported as a volume % of the total amounts of SiC, Al₂O₃, and Al—Si powders, and the amounts of PVP, BBP, stearic acid and carbon are similarly reported as a % of SiC and Al—Si powders. In some preferred embodiments, the core of the catalyst support can be made from a green paste comprising 20 to 40% (or 25 to 40%) Al—Si alloy, 20 to 40% (or 25 to 40%) alumina, 20 to 40% (or 25 to 40%) SiC, and up to 10% (or 1 to 8% or 2 to 6%) inorganic lubricant (preferably graphite) and up to 20% (or 2 to 15%, or 4 to 12%) organic additives (not including liquid solvents). In some preferred embodiments, a powder precursor comprising the Al—Si alloy, alumina and SiC is selected to have a mesh size in the range of about 35 to 200 (or between about 75 to 600 μm in diameter) with at least 80 wt % of the powder precursor in this size range.

TABLE 2

| | |
|---|---|
| Components | Amount (range) |

| | | | |
|---|---|---|---|
| SiC | Grit | 230 | 600 |
| | Vol. % | 10 | 97.5 |
| Al₂O₃ | Median Diameter (μm). | 0.05 | 2 |
| | Vol. % | 0 | 80 |
| Al—Si | Size (μm) | 2 | 25 |
| | Vol. % | 2.5 | 82.5 |

| | | |
|---|---|---|
| PVP + BBP (vol. %) | 0 | 15 |
| BBP/PVP (vol. %) | 0 | 0.5 |
| Stearic acid (wt. %) | 0 | 15 |
| Carbon (wt. %) | 0 | 15 |

The catalyst core comprising SiC and Al₂O₃ can be coated with one or more of these interfacial (or “protective” layers) to further protect the SiC constituent from oxidation when exposed to oxidizing environment at high temperature. Under such conditions, on unprotected SiC, a slow growing, silica scale develops that creates a barrier to further oxygen diffusion into the granule and thus preventing further attack of the substrate. However, a major drawback of the resultant silica scale is its susceptibility to volatilization (e.g., forming Si(OH)₄) and corrosion in the presence of alkali salts (e.g., forming Na₂SiO₄), which limits the applicability. To mitigate this, an outer, “interfacial”, or “protective” coating acts as a barrier between the atmosphere and the SiC surfaces. Each of the one or more interfacial layers comprises alumina, silica, titania, zirconia, or mixtures or oxide compounds of two or more of the foregoing (e.g., mullite). As another example, an outer protective layer of aluminum or of aluminum alloys containing other transition metals or metal mixtures with metal oxides can be applied as a thin coat on the surface of the support material to form an interfacial layer that is converted into a substantially dense oxide layer upon calcination.

One example of this approach is a thin coat of aluminum applied to the core surface. The coating can be applied by a number of methods including but not limited to: dip coating, spray coating, spin coating, or vacuum infiltration.

A protective (or interfacial) alumina coating can be derived from an Al—Si alloy powder, which is deposited in on a SiC/Al composite core, preferably using aerosol deposition under ambient temperature and pressure. For example, the core pellets can be tumbled in an oblate “panning” vessel to create a cascading action. The coating could alternatively be performed on pellets on a moving conveyor or in a fluidized bed to achieve similar coating effects.

The outer, “interfacial”, or “protective” coatings can be applied to a pre-calcined support material, or as disclosed below, to as-formed core shapes. Following calcination, any metal (e.g., aluminum) in the coating is substantially converted into oxides. Preferably, the thickness of the protective oxide layer ranges from 1 to 200 μm, more preferably between about 10 and 100 μm.

The protective or interfacial layer porosity is greater than the pellet core porosity. The protective layer will inhibit gas flow or diffusion into the interior of the pellet. The porosity of the core is preferably in the range of about 1 to 35 vol %, or 10 to 30 vol %, or from about 12 to 20 vol %, while that of the protective layer is less than 40 vol %, more preferably below 30% and, in some embodiments, is in the range of about 0.1% to 30%.

An “interfacial” coating slurry used can vary from an organic solvent and binder system to an aqueous solvent system with polymeric binders, or a combination thereof. The coating material can vary from a pure alumina material to an alumina mixed with other metals, metal oxides, or non-metals. The size of the core and thickness of the interfacial layer are greater in the green state before heat treatment. For example, shrinking in thickness between 3 and 7 times, or 4 and 6 times.

In some preferred embodiments, the green support is heat treated by heating in an atmosphere comprising air to a temperature of about 1300 to 1500° C., or 1350 to 1450° C., or 1380 to 1420° C.; preferably at a rate of 1 to 10° C. per min, or 5° C. or less per minute, and preferably held at this temperature for at least 1 hour or at least 2 h, or in the range of 1 to 5 hour or 2 to 4 h.

Coated pellets are preferably dried and calcined at temperatures ranging from about 800 to 1500° C., preferably between about 1000 and 1450° C., and even more preferably between 1250 and 1400° C. During calcination, the gas atmosphere is typically static air.

### EXAMPLES

### Example 1.1—Description of Making Pellets (Case 1)

### Formulation:

652.6 g of 400 grit SiC (about 40 μm in average diameter), 163.2 g of 1200 grit SiC (about 15 μm in average diameter), and 169 g of Al—Si alloy powder (Valimet Eutectic Alloy 4047 (11-13% Si), grade S-2, 2 μm in average diameter) are combined and transferred to a powder mixer where they are well mixed. Respective weight and volume percent values for the mixture are captured in Table 1.1.1.

TABLE 1.1.1

| | Vendor | Weight | Volume |
|---|---|---|---|
| Material | (grade) | Percent | Percent |
| Al—Si Alloy Powder | Valimet (S-2) | 17.2% | 19.9% |
| Silicon Carbide | Panadyne (400 grit) | 66.3% | 64.0% |
| Silicon Carbide | Panadyne (1200 grit) | 16.6% | 16.0% |
| Total | | 100% | 100% |

### Granulation:

Separately, 3.5 g of PVB is dissolved in 50 g ethanol by stirring and warming. The PVB in ethanol solution is then sprayed into the powder with continuous mixing. The uniformly moist powder is then spread into a shallow bed and dried at 120° C. until completely dry. The dried powder is sieved to 35-200 mesh after drying. To this powder is added 4 wt % stearic acid and 4 wt % graphitic carbon (KS-6) as powder, and homogenized. Enough ethanol is then sprayed onto the agitated powder to moisten the mixture. This mixture is once again dried and sieved through 35-200 mesh prior to pressing.

### Pelleting:

The dry powder blend is dry-pressed into pellets using a laboratory-scale press. Pressing can be performed in either a manual or automated pellet press, and pressure can be applied uniaxially or isostatically.

### Example 1.2—Coating Pressed Pellets (Case 1)

In this example, an organic-based coating system is used. The composition of the coating slurry for interfacial or protective-layer coatings is disclosed in Table 1.2.1. Examples of successful coating formulations ranges are listed but should not be considered limiting in terms of potential coating systems.

The slurry is deposited onto either prior-calcined or prior non-calcined materials cores of the present disclosure. In this example, the coating is deposited onto the core through an organic-based aerosol spray-approach, both manually and alternatively using automated spray equipment. In both approaches, depending on the desired thickness of the final coat, the spraying is performed in either one step or through several repeated coatings with intermediate drying cycles. The drying cycles can be at varying temperatures from about 60° C. to 150° C. in air.

TABLE 1.2.1

Weight Percent in Suspension (%)

| Raw Material | Minimum | Maximum |
|---|---|---|
| Al—Si Powder, S-2 | 5 | 45 |
| Methyl Acetate | 40 | 87.5 |
| Ethyl Cellulose | 0.25 | 5 |
| Alpha Terpineol | 7.5 | 20 |
| Acetylacetonate | 0.5 | 2.5 |

### Example 1.3: Heat Treatment (Case 1)

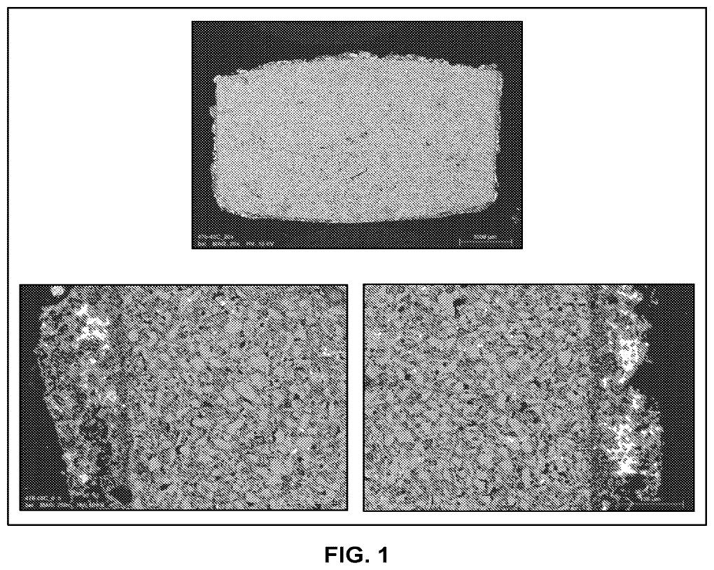

Once dry, the coated pellets are calcined in air at temperatures ranging from about 800 to 1500° C., but preferentially between about 1000 and 1450° C., and even more preferentially between 1250 and 1400° C. The firing profile included two intermediate dwell times at 400 and 600° C. The entire firing profile was as follows: ramp to 400° C. at 3° C./min then dwell at 400° C. for one hour before ramping to 600° C. at 2° C./min then dwelling at 600° C. for two hours before ramping to the final temperature at 2° C./min and dwelling for one hour. Examples of the resulting microstructures are shown in the photomicrographs in FIG. 1.

### Example 1.4 (Case 2)

### Formulation:

To produce the core of the catalyst support, powders of Al—Si alloy (S-2, Valimet), Aluminum Oxide (A-1000 SG Almatis), and SiC powder (400 grit, Panadyne) were first blended in an Eirich Mixer EL10 (Model No RV02E). Specific amounts are shown in Table 1.4.1.

TABLE 1.4.1

| Material | Vendor (grade) | Weight % | Volume % |
|---|---|---|---|
| Al—Si Alloy Powder | Valimet (S-2) | 33.3 | 39.7 |
| Aluminum Oxide | Almatis (A-1000 SG) | 33.3 | 26.9 |
| Silicon Carbide | Panadyne (400 grit) | 33.3 | 33.4 |
| Total | | 100 | 100 |

### Granulation:

To make the material acceptable for dry pressing, binder and lubricant materials are added in a manner to homogenize the powders and granulate them to allow good flow of the dry material during operation of the automated pelleting press. The powders are weighed to produce a 6000-g batch of inorganic materials at the ratios listed in Table 1.4.1 and homogenized in the bowl of the Eirich mixer. Powders are agitated for 120 seconds at 10 meters per second arm speed, while the bowl is rotated in the counterclockwise direction at low speed. The agitation is adjusted to 18 meters per second as 425 g of an ethanol solution (92.9 wt %) of polyvinyl butyral (6.6 wt %) and butyl benzene phthalate (0.5 wt %) is added gradually to the mixture over a five-minute interval. When the entire solution is added, the arm speed is increased for five minutes to evaporate the ethanol solvent. Two additional binder deposition-drying cycles are performed to complete binder addition. The resulting clay-like body is passed through a #14 mesh, divided into stainless steel pans, and dried for 25 minutes at 60° C. in a forced air oven. The dried material is removed from the pans, sieved through −35/+200 mesh, separating the +35 and −200 mesh fractions for recycle.

Sieved powder is then returned to the Eirich mixer, and four percent of the sieved powder weight of stearic acid powder (Alfa Aesar, A17673, 90+ %) and four percent of the sieved powder weight of synthetic graphite powder (Timcal, KS-6)) are added to the granules and dry mixed for 5 minutes. Additional binder solution is added to the blended powder to further agglomerate the material and entrain the lubricants. The binder solution is added stepwise with intermediate drying until the full amount is added.

The powder is again sieved through a #14 mesh, dried for 5 minutes in a 60° C. oven, then sieved between 35 and 200 mesh to produce a final product. This material is dried for an additional hour at 60° C.

In summary, the Case 2 formula is: 29.96 wt % SiC-400, 29.96 wt % Al₂O₃, 29.96 wt % Al—Si, 2.59 wt % PVB, 0.19 wt % BBP, 3.65 wt % Stearic Acid, 3.65 wt % carbon when corrected for total final material composition after drying.

### Pelleting:

The granulated powder can be pelleted using a range of uniaxial or isostatic presses. As an example, the granulated powder is added to the hopper of an automated uniaxial pelleting press (Korsch, Model EKO), which produces pellets of 6 mm in diameter, ˜4 mm in height, from 0.25 g of powder. The resulting pellets are mechanically robust, glossy, and have a uniform internal structure free from gross defects.

### Example 1.5: Al—Si Coating Pressed Pellets (Case 2)

To prepare an interfacial or protective coating suspension, 100 g of an Al—Si alloy powder (Valimet S-2, 11-13% Si) with a D50 of 3.5 μm is added to a 1-liter Nalgene container, in which a solution of 300 g methyl acetate, 72.5 g alpha terpineol and 27.5 g screen printing vehicle (Heraeus V006A) is prepared.

The composition of the coating slurry for third-layer coatings is disclosed in Table 1.5.1. Examples of successful coating formulations ranges are listed but should not be considered limiting. The slurry is deposited onto either prior-calcined or prior non-calcined materials cores of the present disclosure. In this example, the coating is deposited onto the core through an organic-based aerosol spray-approach, both manually and alternatively using automated spray equipment. In both approaches, depending on the required thickness of the final coat, the spraying is accomplished in either one step or through several repeated coatings with intermediate drying cycles. The drying cycles can be at varying temperatures from about 60 to 150° C.

The Nalgene container is then placed on rotating rack and ball milled for 8 h at 25 RPM. After the milling operation, the suspension is decanted from the mill into a reservoir. Using an aerosol nozzle, the suspension is deposited on as-pressed SiC/Al pellets, as described below.

TABLE 1.5.1

Weight Percent in Suspension (%)

| Raw Material | Minimum | Maximum |
|---|---|---|
| Al—Si Powder, S-2 | 5 | 45 |
| Methyl Acetate | 40 | 87.25 |
| V006A (Heraeus) | 0.25 | 10 |
| Alpha Terpineol | 7.5 | 20 |

Pellets (300 g, about 6 mm diameter, about 4 mm height) are loaded into a pellet coater (BYC-600, Jiawanshun) with a 60 cm diameter vessel, turning at a rotation rate of 20 RPM for 0.5 h. This operation serves to remove asperities and high-radius-of-curvature features from the pellets. Residue from the polishing process is removed from the chamber prior to coating.

Coating is performed using a pellet coater (BY-200, Jiawanshun) with a 20 cm diameter vessel, turning at a rotation rate of 20 RPM. Coating is aerosol deposited in 10-15 second intervals, alternating with 40-50 second intervals of warm, dry air flow. Between the drying step and subsequent coating steps, the pellets are allowed 15-20 seconds to equilibrate. Coating-drying-equilibration is performed in iterations of 5 cycles.

Additional coating-drying-equilibration cycles are performed to achieve a deposition target of about 0.04 g of alloy per gram of pellets, or approximately 0.01 gram of coating per 0.25-gram pellet.

Dip or wash coating using aqueous or solvent based suspensions at ambient pressure or vacuum conditions can achieve similar microstructures. It may also be possible to achieve similar coatings through dry tumbling of cores with a mixture of aluminum powder and appropriate binders.

The size of the core and thickness of the interfacial layer are greater in the green state before heat treatment. Dimensions are reduced from about 125 to 25 μm thick in the as applied state to about 100 to 20 μm thick after firing or heat treatment.

### Example 1.6: HP 3.0 Heat Treatment

After the targeted coating weight has been applied to the pellets, they are placed into an alumina saggar and heated in air to a 1400° C. at a rate of about 3° C. per minute, then held for three hours, and cooled to room temperature at a rate of about 5° C. per minute. The fired, coated pellets are blown with compressed air to remove any loose particulates from the coating operation.

In some preferred embodiments, the green support is heat treated by heating to a temperature of about 1300 to 1500° C., or 1350 to 1450° C., or 1380 to 1420° C.; preferably at a rate of 1 to 10° C. per min, or 5° C. or less per minute, and preferably held at this temperature for at least 1 hour or at least 2 h, or in the range of 1 to 5 hour or 2 to 4 h.

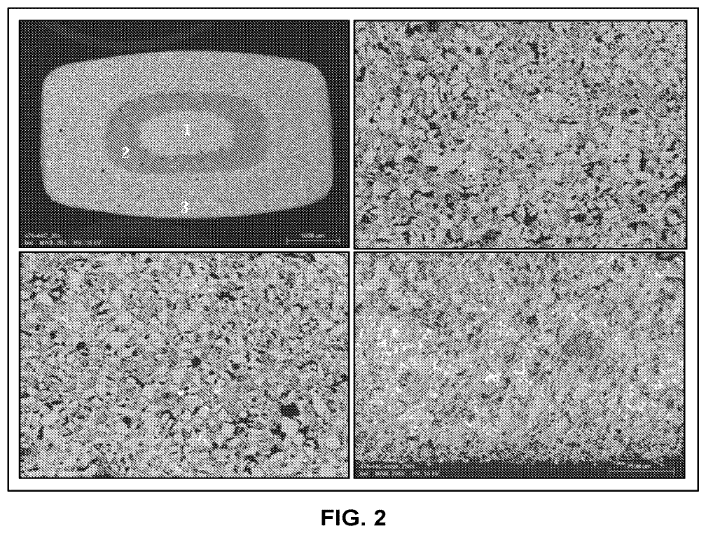

Micrographs of the resulting pellets were obtained. A representative example is shown in FIG. 2. In contrast to the microstructure of FIG. 1, there are multiple preferable features of the resultant pellets. Beginning from the exterior and working inward, the coating comprising alumina at the surface is much more uniform in composition and microstructure, and can be delineated from the underlying core by the absence of Si-containing phases when evaluated by EDS. This is different from FIG. 1, where there is evidence of significant segregation of Si and the formation of Si-containing phases as shown by EDS.

Further, the coating and core of Case 2 is less porous than Case 1. This has been documented by stereological analysis of the microstructures using Image J software (www.imagej.nih.gov), to determine the fraction of pores in the microstructure in different sections of the pellet. It is well established that the area fraction of phases observed in 2D images are representative of the volume fraction of the same phases observed in the three-dimensional structure. Table 1.6.1 captures the measured pore fraction in the core and the protective layer for Case 1 and 2 parts fired at 1400° C. The protective or interfacial layer porosity is greater than the core porosity.

The Case 2 microstructure has been shown to be substantially impermeable to subsequent coating slurries that are coated onto the pellets, which develops a distinct catalyst coating layer.

The volume percent porosity for the core and the protective layers are determined by measuring the area fraction of pores in the region of a 2D section micrograph. Multiple sample areas (at least 5) are used to provide a representative analysis. Similarly, the area fraction of various phases can be determined from energy dispersive X-ray spectroscopy (EDS) images (at least 5) of similar 2D sections.

TABLE 1.6.1
Pellet porosity by two methods of synthesis
Porosity of Core and Layer for Parts Sintered
at 1400° C., per Examples above

| | | | | Protective or |
|---|---|---|---|---|
| | Outer Pellet | Interior Pellet | Center Pellet | Interfacial |
| Case | Porosity | Porosity | Porosity | Layer Porosity |
| 1 | 14.3 | 17.2 | 20.8 | 38.2 |
| 2 | 16.9 | 20.04 | 14.2 | 27.7 |

### Comparative Trends in Oxygen Concentration Example 1.2 (Case 1) and 1.4 (Case 2):

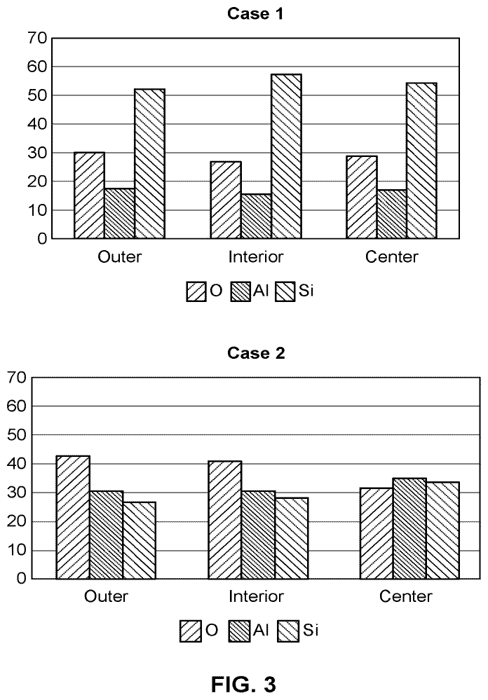

An important difference in the Case 1 and Case 2 examples is the difference in oxygen content from the exterior to the interior of the pellet. Using Electron Dispersive X-Ray Spectroscopy, the concentration of O, Al and Si were measured at locations near the surface, the interior, and the middle of the pellets from the SEM/EDS analysis-such as shown in the color figures shown in U.S. provisional patent application Ser. No. 63/294,844, incorporated by reference as if reproduced in full below. From these analyses, the graphs in FIG. 3 result.
Case 1. In this case, the levels of oxygen, Al, and Si show only slight variation through the thickness of the part. This is indicative of an oxygen path for diffusion from the exterior to the innermost core of the pellet during heat treatment, which also leads to a generally consistent microstructure (FIG. 1). As a result, the concentration of Al, Si, and O are relatively similar and consistent through the diameter of the pellet.
Case 2. In this case the compositional levels of Al, Si, and O are not uniform. At the exterior and interior layers, the path for oxygen diffusion is poor. As a result, the concentration of Al, Si, and O are not consistent through the layers of the pellet.
a. The outermost, most oxidized layers have oxygen content consistent with complete oxidation of the alloy.
b. The intermediate layer has a similar level of oxidation, but tends to display more porosity, and in some cases, evidence of residual Al-based alloy.
c. The innermost center of the pellet has a clearly depressed oxygen content, and a significant fraction of Al-alloy.

### Thermal Sintering and Expansion Behavior of Example 1.2 (Case 1) and 1.4 (Case 2) Cores.

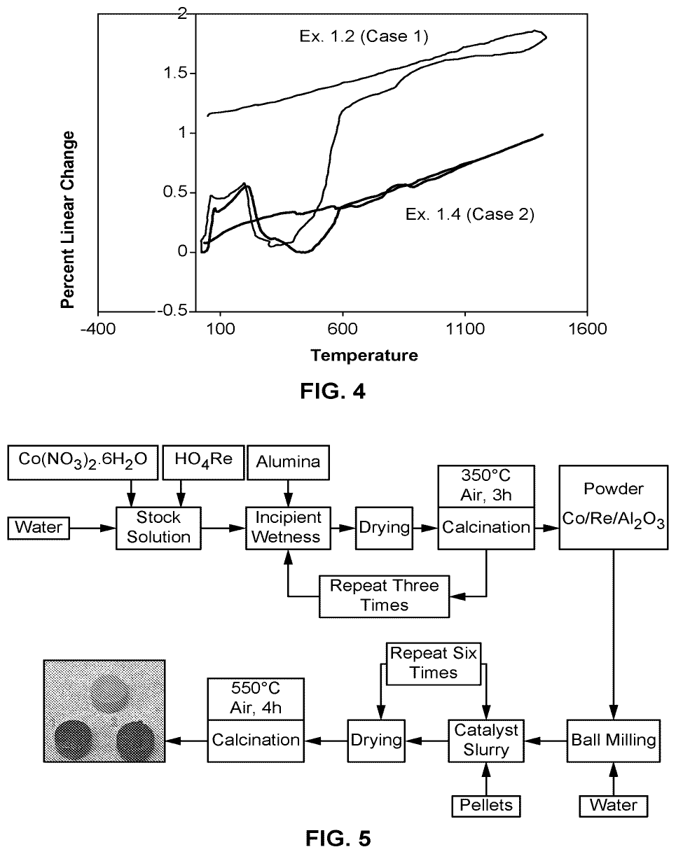

The thermal sintering and expansion behavior of core samples without coating from Examples 1.2 and 1.4 were evaluated by heating samples at 1° C./minute to 1400° C. to determine the difference in sintering contraction and expansion during heat treatment. As shown in FIG. 4, both samples show similar features of sintering, with initial expansion until binder melting and rearrangement of the composite begins at 210° C. The parts shrink until expansion of the parts begins in the temperature range of 350 to 450° C., levels into a more gradual expansion above 600° C. On cooling, the samples exhibit nominally linear shrinkage with temperature.

The Example 1.2 (Case 1) sample has more significant overall expansion through the thermal cycle, compared to the Example 1.4 (Case 2) sample, and a lower thermal expansion coefficient after reaching the upper setpoint, shown in Table 1.6.2. Considering how these cores may interact with the transitioning aluminum-to-alumina protective coating, it would be preferable to minimize overall expansion/shrinkage (Case 2) and having a thermal expansion coefficient closer to alumina (8.5 ppm/° C.) to reduce stresses during heating and cooling. These shrinkage behaviors may contribute to observed differences in the protective coating density between Cases 1 and 2.

TABLE 1.6.2
Comparing two methods of pellet synthesis

| | | Coefficient of | Sintering Expansion |
|---|---|---|---|
| | | Thermal Expansion | over Thermal |
| | | (1350-600° C. range) | Cycle (percent |
| Example | Case | in ppm/° C. | linear change) |
| 1.2 | 1 | 5.4 | 1.15% |
| 1.4 | 2 | 7.0 | 0.05% |

Surface Area: The Brunauer-Emmett-Teller (BET) surface area, is measured by the adsorption and desorption of physi-sorbed nitrogen molecules from the surface of powders. Another parallel technique, the method of Barrett, Joyner, and Halenda (BJH) is a procedure for calculating pore size distributions from experimental isotherms using the Kelvin model of pore filling. As observed in the data above, the Case 2 embodiment has lower surface area per gram (about half that of Case 1), indicating that the outer protective coating is less open to fluid ingress, an observation supported by the smaller pore area and volumes measured for Case 2 versus Case 1 (Table 1.6.3).

TABLE 1.6.3
Pellet properties by two synthesis methods
BET Surface Area and BJH Adsorption/Desorption
Porosity Analysis of Comparative and Current Examples

| | | | | BJH | BJH | | |
|---|---|---|---|---|---|---|---|
| | | BJH | BJH | adsorption | desorption | BJH | BJH |
| | | adsorption | desorption | Pore | Pore | adsorption | desorption |
| | BET SA | Pore Area | Pore Area | Volume | Volume | Pore Width | Pore Width |
| Example | (m²/g) | (m²/g) | (m²/g) | (cm³/g) | (cm³/g) | (nm) | (nm) |
| Case 1 | 0.3926 | 0.1909 | 0.2193 | 0.001045 | 0.000985 | 10.9 | 9.0 |
| Case 2 | 0.2009 | 0.1293 | 0.1193 | 0.000657 | 0.000635 | 10.2 | 10.6 |

Thermal Conductivity: The thermal conductivity of the Case 1 and Case 2 cores were measured using the ASTM E1461, Standard Test Method for Thermal Diffusivity and Conductivity by the Flash Method. Data was collected over a range of temperatures for uncoated core samples Case 1 and Case 2 sintered at 1300° C. As shown in Table 1.6.4, over the entire range of conditions, the composites show comparably favorable high thermal conductivity, despite significant differences in silicon carbide and alumina composition and the difference in porosity in the cores.

TABLE 1.6.4
Thermal Conductivity of Case 1 and Case 2 Cores, Sintered at 1300° C.
Thermal Conductivity (W/m · K)

| Example | 800° C. | 600° C. | 400° C. | 200° C. | 25° C. |
|---|---|---|---|---|---|
| Case 1 Core | 11.89 | 13.2 | 16.13 | 20.88 | 28.05 |
| Case 2 Core | 8.81 | 9.31 | 9.56 | 12.98 | 20.46 |

### Example 2. Catalyst Preparation

A Cobalt-based Fischer Tropsch catalyst is prepared in a powder form for subsequent testing both in a granulated form and as coated on a pellet as described in Examples 1.4 to 1.6.

### Materials and Chemicals

Alumina support (98% Al₂O₃, PURALOX®TH 100/150 L4) is obtained from Sasol. Co(NO₃)₂·6H₂O (98%) and perrhenic acid solution (HO₄Re, 75-80 wt. % in H₂O) are purchased from Sigma-Aldrich and used as received. Pellets were prepared using the method described in Example 1.

### Preparation of Catalysts

The Al₂O₃ support is pre-calcined at 500° C. in air for 2 h (ramping rate: 5° C./min) and stored in a desiccator. 46 g Co(NO₃)₂-6 H₂O and 1.1 mL HO₄Re solution are dissolved in 22 mL H₂O as a stock solution. 8 mL stock solution is added to 20 g pre-calcined Al₂O₃ support via an incipient wetness impregnation method, followed by drying at 90° C. for 8 h and calcination at 350° C. for 3 h in air at a ramp rate of 5° C./min. The procedure is repeated twice with 7 mL stock solution added to the solid mixture until the entire 22 mL stock solution is used. The process for preparing the catalysts is shown in FIG. 5. The obtained powder catalyst weighed ˜35 g and is referred to as Co/Re/Al₂O₃ catalyst. The nominal loadings of Co and Re are 30.3 wt %, and 4.8 wt %, respectively within the high surface area alumina support.

To prepare a catalyst slurry, 3 g of the Co/Re/Al₂O₃ catalyst is ball-milled with 17 mL water for 3 h. Pellets as prepared in example 1 are dip-coated in the catalyst slurry and dried at 80° C. in air to create a thin and uniform coating. The dip-coating process is repeated 6 times. Coated pellets are calcined at 550° C. for 4 h in air with a ramp rate of 5° C./min. Each pellet has about 5.9±1.1 mg Co/Re/Al₂O₃. The catalyst preparation steps are shown in FIG. 5 along with the as-received pellet (top) and pellet with a thin Co/Re/Al₂O₃ coating (1) and pellet with excess amount of slurry coating (2). Pellets with thin Co/Re/Al₂O₃ coating were used for further studies as described in Examples 3 to 13.

### Example 3. Catalyst Pellet Loading in Reactor

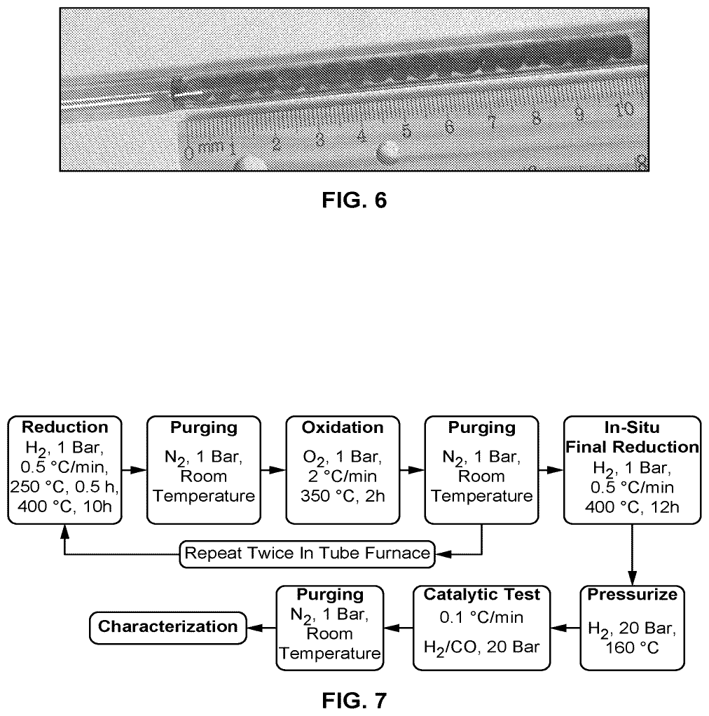

Catalysts were evaluated in Fischer-Tropsch (F-T) reaction using a fixed-bed plug-flow type reactor consisting of a quartz tube with an inner diameter of 7 mm. The reactor quartz tube was placed at the center of a stainless-steel housing. For powder catalyst testing, Co/Re/Al₂O₃ catalyst was first sieved between 60 and 120 mesh (or about between 125 and 250 μm in diameter) and 0.4398 g of total pellet weight was packed in the quartz reactor (catalyst fixed bed height of 19 mm as held with glass wool on either side of the granulated catalyst). For pellet catalyst testing, twenty pellets with a total of 0.1108 g Co/Re/Al₂O₃ coated catalyst were packed in the quartz reactor with alternating horizontal and vertical pellet placement as seen in FIG. 6, with a total packed bed height of about 0.105 m.

The pellets were loaded with the aid of extended length tweezers while in a substantially horizontal orientation during loading. The loaded or packed tube was moved to a vertical orientation as desired for reactor operation. This loading configuration has an estimated bed void fraction of 0.56. Each pellet is 3.64 mm high by 6.04 mm diameter as measured before catalyst coating. For each pellet when packed there is about a 0.5 mm gap between the pellet and the internal surface of the reactor tube.

### Example 4. Catalyst Activation Prior to Operation

The activation of both powder and pellet catalysts is conducted in a tube furnace involving two redox cycles, with each consisting of two steps: 1) reduction of the catalysts with 10% H₂ in N₂ at 1 bar (flowing at 50 cm³ min⁻¹), ramping from room temperature to 250° C. at a rate of 0.5° C./min with 30 min hold at 250° C., followed by ramping to 400° C. at a rate of 0.5° C. min/min with 10 h hold at 400° C. before switching to N₂ (50 cm³ min⁻¹) and then cooling down to room temperature; 2) oxidation of the catalysts with 1% O₂ in N₂ at 1 bar (50 cm³ min⁻¹), ramping from room temperature to 350° C. at a rate of 2° C./min with a 2 h hold at 350° C. followed by switching to flowing N₂ (at 350° C. and 50 cm³ min⁻¹) and cooling down to room temperature. After the above two steps are repeated to fulfill two redox cycles, the catalysts are transferred to the isothermal region of the reactor, and the final reduction is performed in situ with H₂ at 1 bar (25 cm³min⁻¹) up to 400° C. for 12 h, at a rate of 0.5° C./min.

The initial catalyst redox activation steps are conducted in a separate testing apparatus (a tube furnace) than the reactor test stand for operation. By this method, exemplar catalysts could be activated separately from the final reactor installation except for the final reduction step in hydrogen. The catalyst is reduced in hydrogen prior to operating the FT reaction. The separate redox steps of catalyst activation acts to reduce complexity and cost, while improving safety of in situ redox catalyst activation for a Fischer Tropsch facility. The activation and reduction prior to operation is shown in FIG. 7.

### Example 5. Reactor Operation

After catalyst activation as described in Example 4, the reactor temperature is ramped down from 400° C. to 160° C. where the total pressure was raised to 20 barg in a H₂ flow of 25 sccm and then the gas was switched to a H₂ and CO feed mixture with a H₂/CO ratio of 2. The target temperature is approached using a heating rate of 0.1° C. min/min. It is understood that all reported reaction pressures refer to measured gauge pressure and are denoted as either bar or barg.

Catalytic activities and product selectivity were measured after at least 12 h TOS when the system approaches steady state using an on-line chromatography-mass spectrometry equipped with two sampling loops (GC-MS, Agilent 7890A-5975). The GC/MS system and the outlet of the reactor were connected through a capillary which was maintained at 200° C. by a heating tape to avoid condensation of heavy products. Light gases (up to C₃) were measured by a thermal conductivity detector (TCD) with two connected columns of 3 Foot and 9 Foot Hayesep Q 80/100 (in backflush mode), while C₄₊ hydrocarbons and alcohols were analyzed by an MS detector and the DB-1 capillary column. The conversion of CO was calculated from the sum of all carbon products and the carbon balance.

### Product Analysis

C₁-C₃ were analyzed by a thermal conductivity detector (TCD) with two connected columns of 3 Foot and 9 Foot Hayesep Q 80/100 (in backflush mode), while C₄-C₁₃ were analyzed by a MS detector with the DB-1 capillary column. Calibration of the TCD and MS signals vs concentrations (mol %) was performed using standard calibration gas mixtures.

C₄-C₁₂ mass fractions were used to calculate alpha numbers then extrapolated to C₃₂ (external analysis of samples confirm the presence of hydrocarbons, HCs, up to C₃₂) and normalized to C₁-C₃₂. Limited by the GC-MS system, quantitative analysis of paraffins can only be accurately performed on the C₁-C₁₂ fractions. The alpha numbers for paraffins were calculated from C₄-C₁₂ as the C₁-C₃ fractions do not follow the Schulz-Flory distribution as expected. External analysis of samples confirmed the presence of HCs up to C₃₂ so linear extrapolation estimated paraffins to C₁₃-C₃₂ by using the alpha numbers calculated from C₄-C₁₂. The alpha numbers were calculated based on the Anderson-Schulz-Flory equation Wₙ=n(1−α)²αⁿ⁻1 where Wn stands for the mass fraction of products containing n carbon atoms. CO conversion is calculated using:

$${X}_{CO} = \frac{\sum {n}_{i}^{C}}{{n}_{CO}^{out} + \sum {n}_{i}^{C}}$$

CH₄ selectivity is calculated using:

$${S}_{C {H}_{4}} = \frac{{n}_{C {H}_{4}}}{\sum {n}_{i}^{c}}$$

### Where:

n_{CO}^{out} is the amount of CO unconverted in a molar basis
n_{CH}_{₄} is the amount of CH₄ produced in a molar basis

$$\sum {n}_{i}^{c} = 1 ( {n}_{C {H}_{4}} + {n}_{C {H}_{3} O H} ) + 2 ( {n}_{{C}_{2} {H}_{6}} + {n}_{{C}_{2} {H}_{4}} + {n}_{{C}_{2} {H}_{5} O H} ) + 3 ( {n}_{{C}_{3} {H}_{8}} + {n}_{{C}_{3} {H}_{6}} + {n}_{{C}_{3} {H}_{7} O H} ) + … . ( mole ) .$$

Catalyst productivity (in g CO converted per g_{cat} per hour) is calculated using:

$$Catalyst productivity ( {g}_{C O} {g}_{Cat}^{- 1} {h}^{- 1} ) = \frac{weight of CO consumed ( g )}{weight of catalyst ( g ) \times h}$$

The weight of catalyst is defined by the weight of dried catalyst as coated by a slurry or other method and retained on the exterior of the pellet. The catalyst weight includes Co, Re, other promoters, and the high surface area support upon which the active material is placed. The weight of the catalyst as used for subsequent productivity analyses does not include the weight of the underlying Al—Si pellet nor its protective or interfacial layer.

### Example 6. Comparison of Powders and Pellets at 195 C

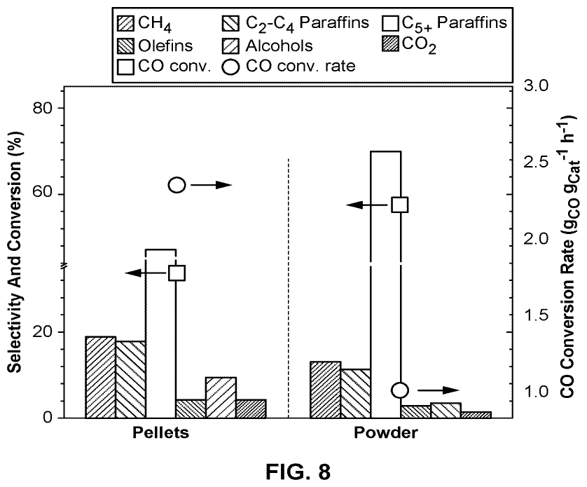

Both powder and catalyst-coated pellet catalysts were compared at a reaction temperature of 195° C. as measured by a thermocouple at the end of the catalyst bed. Further, the pressure was held constant at 20 barg and data collected at a time-on-stream (TOS) of 110 and 131 h, respectively. A feed gas mixture of H₂ and CO with H₂/CO ratio set at 2 was controlled with a total flowrate of 30 ml/min (STP) without additional diluents. As shown in FIG. 8, the pellet catalyst at this temperature showed a lower CO conversion than that of powder catalyst, 34.30% vs 57.03%, and a relatively higher methane selectivity, 18.89% vs 12.63%. Very little wax was formed in liquid products which was further confirmed by analysis of two liquid products (high temperature distillation to get a carbon distribution of mass fraction by carbon number).

Pellet catalyst at this low temperature also showed slightly higher selectivity to olefins, alcohols (mainly methanol, ethanol, and 1-propanol), and CO₂. Nevertheless, the pellet catalyst showed a much higher CO conversion rate than powder catalyst, i.e., 2.34 vs 0.97 g CO converted/g_{cat}/h at 195° C. The gram catalyst in this calculation refers to the total weight of Co/Re/Al₂O₃ catalyst which is either directly loaded for the granulated powder tests or the total and smaller amount as coated for the pellet tests. The data is shown graphically in FIG. 8, and in tabular form in Table 6.2.

TABLE 6.2
Summary data table comparing powder and pellet performance at 195° C.

| | | | | | | | | | | | | | | CO |
|---|---|---|---|---|---|---|---|---|---|---|---|---|---|---|
| | | | | | | | | | | | | | | Conv. |
| | | | | | | | | | | | | | | Rate |
| | | | Total | Hold | | | | | | | | | | (g_{CO} |
| | | | flow | time | CO conv. | | | C2-C4 | C5+ | | | | | g_{Cat}⁻¹ |
| Sample | TOS, hr | T(° C.) | (ml/min) | (h⁻¹) | (%) | CH₄ | Paraffins | Paraffins | Paraffins | Olefins | Alcohols | CO₂ | H₂/CO | h⁻¹) |
| Powder | 110 | 195 | 30 | 16 | 57.03 | 12.62 | 93.37 | 11.15 | 69.61 | 2.51 | 3.08 | 1.04 | 2 | 0.97 |
| Pellets | 131 | 195 | 30 | 25 | 34.30 | 18.89 | 82.96 | 17.89 | 46.19 | 4.01 | 9.05 | 3.98 | 2 | 2.34 |

### Example 7. Effect of Temperature on Powder and Pellets at 20 Barg

The effect of temperature on both powder and pellet catalyst performance was evaluated from 180 to 220° C. with a feed gas mixture of H₂ and CO (H₂/CO ratio of 2). The gas flow rate was adjusted from 30-40 ml/min (STP) for powder catalyst and 15-30 ml/min (STP) for pellet catalysts to control CO conversion.

For the powder catalyst, as the temperature increased from 185 to 195° C., the CO conversion rate increased from 0.69 to 0.97 g CO converted/g_{cat}/h. The selectivity to olefins and alcohols decreased while CH₄ selectivity maintained relatively constant at ˜12.5%. When temperature was increased to 200° C., the powder catalyst experienced reaction runaway as indicated by nearly 100% CO conversion or a CO conversion rate of 2.27 g of CO converted/g_{cat}/h while CH₄ selectivity continuously increased from 28.92% at 16 h TOS at 200° C. to 63.07% at 20 h TOS also at 200° C.

After lowering the temperature to 195° C. after the runaway event, the CO conversion remained at 100% (CO conversion rate of 2.27 g_CO converted/g_{cat}/h) and a high CH₄ selectivity of 48.5% was observed. Further lowering temperature down to 190° C. did not reduce CH₄ selectivity (48.09%) and still gave a CO conversion of about 100% (CO conversion rate of 1.70 g_CO converted/g_{cat}/h). Catalyst performance before and after reaction runaway at 200° C. is significantly different in terms of CO conversion rate and CH₄ selectivity. The catalyst deactivated after the reaction ran away. Further characterization of spent powder catalyst by TEM, XRD, and Raman analysis showed the formation of undesired Co aluminate spinel and graphitic carbon deposits on the spent powder catalysts (characterization data described in Example 13).

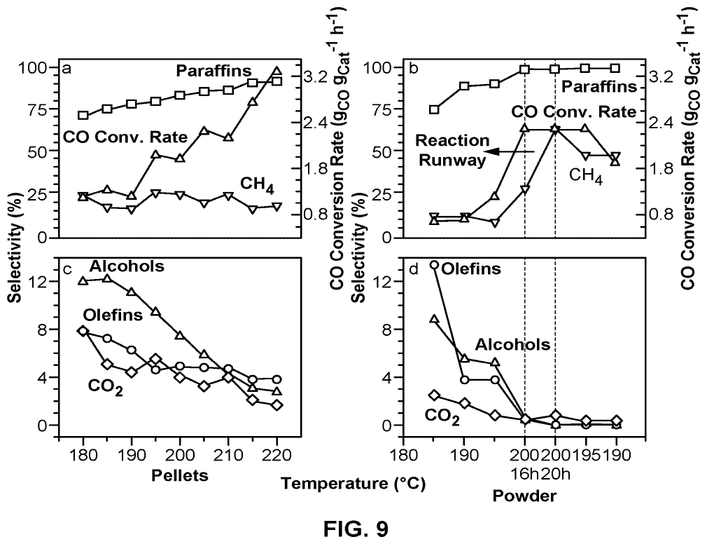

For the coated pellet catalyst, there was no reaction runaway. CO conversion rate increases with temperature even up to 220° C. and beyond while CH₄ selectivity remained relatively constant. Selectivity to alcohols, olefins, and CO₂ decreased with increasing temperature. A high CO conversion rate of 3.28 g CO per g-catalyst per hour was reached at 220° C. while maintaining a CH₄ selectivity of 18.93%. Data is shown in FIG. 9.

### Example 8. Effect of H₂/CO feed ratio on pellets performance at 20 barg and 225° C.

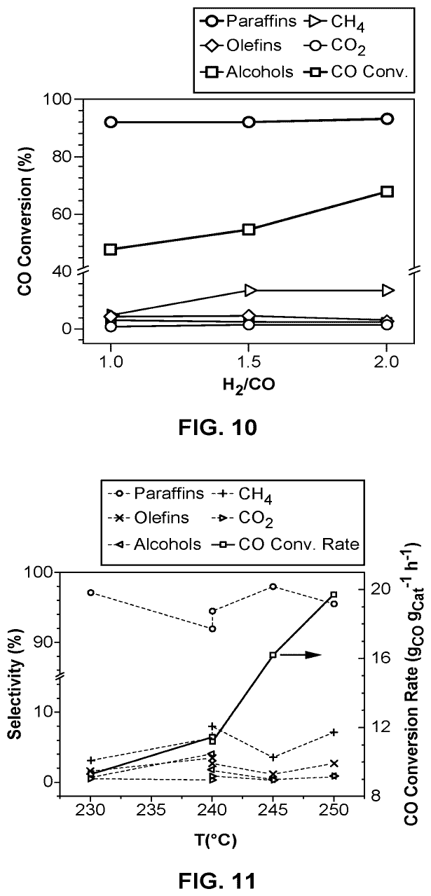

The effect of H₂/CO feed ratio on the pellet catalyst was studied at 225° C. As the H₂/CO feed ratio increased from 1 to 2, the CO conversion increased from 46.68 to 67.2% while the CH₄ selectivity also slightly increased to ˜14%, as expected. Selectivity to paraffins, olefins, and alcohols remained relatively constant across this range of H₂ to CO feed ratio. The data is shown graphically in FIG. 10 and summarized in Table 8.2.

TABLE 8.2
Data summary for effect of H₂/CO ratio in the range of 1 to 2 on the exemplar pellet catalyst at 225° C. and 20 barg.

| | | | Total | Hold | CO | | | | | | | | |
|---|---|---|---|---|---|---|---|---|---|---|---|---|---|
| TOS | T | | flow | time | conv. | | C₂-C₄ | C₅₊ | | | | | CO Conv. Rate |
| (h) | (° C.) | H₂/CO | (ml/min) | (h) | (%) | Paraffins | Paraffins | Paraffins | Olefins | Alcohols | CH₄ | CO₂ | (g_{CO} g_{Cat}⁻¹ h⁻¹) |
| 342 | 225 | 1 | | 17 | 46.68 | 92.03 | 6.24 | 81.13 | 4.96 | 2.28 | 4.66 | 0.73 | 4.79 |
| 301 | 225 | 1.5 | | 22 | 53.51 | 91.99 | 9.58 | 68.09 | 4.21 | 2.15 | 14.32 | 1.64 | 3.66 |
| 257 | 225 | 2 | 30 | 17 | 67.20 | 93.12 | 10.69 | 68.68 | 2.80 | 2.21 | 13.75 | 1.87 | 4.59 |

### Example 9. Effect of Temperature at 1.8 H₂/CO Ratio on Pellets at 20 Barg

To test the exemplar pellet catalyst over a wider range of temperatures, pellet catalyst performance was studied from 230 to 250° C. with a H₂/CO feed ratio of 2. The coated pellet catalyst did not experience reaction runaway under any conditions. The gas flow rate was varied between 56 and 140 ml/min (STP) to maintain CO conversion between about 40.8 and 79%. As the temperature increased from 230 to 250° C., the CO conversion rate increased from 9.33 to 19.7 CO converted/g_{cat}/h while CH₄ selectivity was maintained below 10%. CH₄ selectivity of 7.29% was obtained at the 19.7 g of CO converted/g_{cat}/h (g/g/h) productivity. The data is shown in FIG. 11.

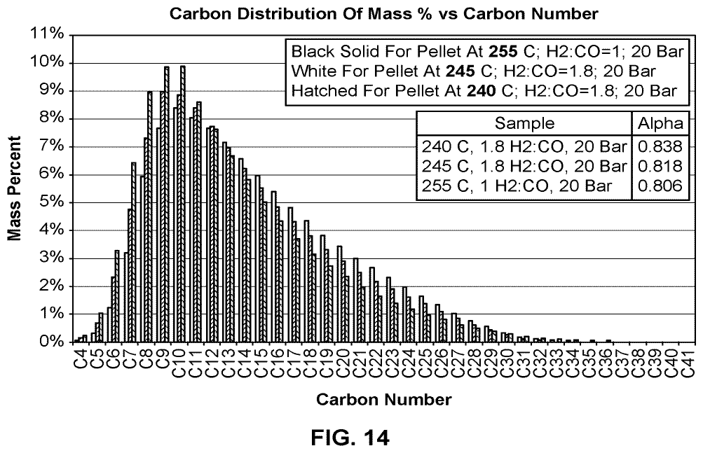

Selectivity to alcohols, olefins and CO₂ remained relatively constant. A low CH₄ selectivity of <7% even at 240° C. and 245° C. is consistent with high alpha numbers of 0.84 and 0.82, respectively, based on the liquid product analysis (as seen in the white and hatched bars in FIG. 14) conducted using high temperature distillation. Long-chain hydrocarbons as high as C₃₂ were detected in the liquid sample analysis which is consistent with a significant amount of wax observed in both samples. A high CO conversion rate at 250° C. and 20 barg of 19.7 g CO converted/g_{cat}/h achieved on the exemplar pellet catalyst represents more than 20 times higher productivity than the corresponding powder catalyst and does so without reaction runaway.

### Example 10. Effect of Temperature at 1.6 to 1.65 H₂/CO Ratio on Pellets at 20 Barg

Pellet catalysts were studied at higher temperatures, from 230 to 255° C., and a feed ratio of H₂/CO near ˜1.6 to confirm applicability for high temperature operation without thermal runaway while controlling CH₄ selectivity and producing long chain hydrocarbon products. The gas flow rate was adjusted between 56 and 130 ml/min (STP) to maintain CO conversion between about 39.4 and 80.5%.

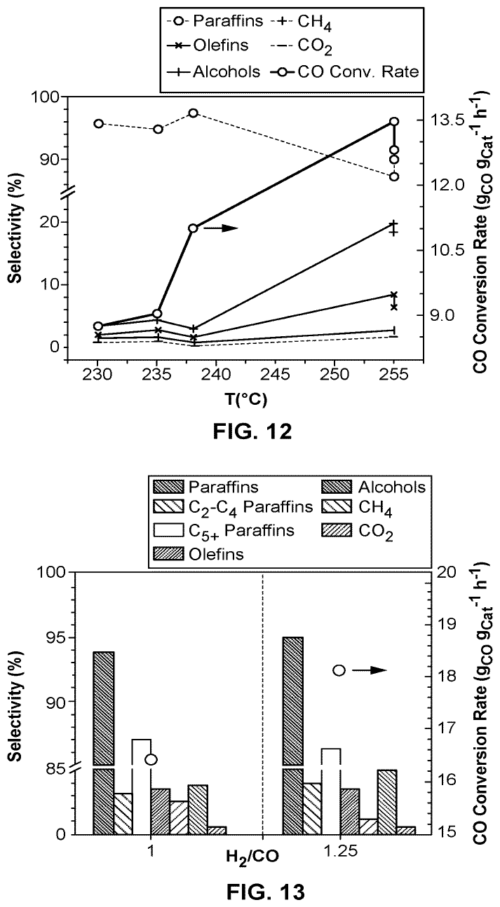

As the temperature increased from 230 to 255° C., CO conversion rate increased from 8.75 to 13.47 g of CO converted/g_{cat}/h while CH₄ selectivity was maintained below 6%. Selectivity to olefins slightly increased while paraffin selectivity slightly decreased with increasing temperature. Selectivity to alcohols and CO₂ remained relatively constant over this temperature range. Data is shown in FIG. 12.

### Example 11. Effect of Feed H₂/CO Ratio at 255° C. on Pellets at 20 Barg

The exemplar pellet catalyst performance at much lower feed H₂/CO ratios of 1 and 1.25 at 255° C. is described. Gas flow rates were controlled at 80 and 90 ml/min (STP) for the runs with H₂/CO ratios of 1 and 1.25, respectively. A higher CO conversion (66.3%) was obtained at a H₂/CO of 1.25 compared to that at a H₂/CO equal to 1 (60% CO conversion), corresponding to a slightly higher CO conversion rate (18.12 vs 16.41 g CO converted/g_{cat}/h).

A slightly higher CH₄ selectivity was obtained at a H₂/CO ratio of 1.25 compared to that at a feed H₂/CO ratio of 1 as seen in FIG. 13. Nevertheless, under both H₂2/CO feed ratios, very low CH₄ selectivity (<5%) was achieved at 255° C., which is consistent with wax observed in the liquid sample vial (hatched sample shown in FIG. 14). For this case, an alpha number of about 0.81 was calculated based on the liquid sample analysis provided by high temperature distillation. This sample was collected from the experiment with a H₂/CO ratio of 1. In addition, a slightly higher selectivity to alcohol was observed at a lower H₂/CO ratio of 1.

There was a system upset with an interrupted H₂ flow (stopped) between TOS from 554 to 568 h. During this window only CO was fed to the reactor. Specifically, the catalyst test was conducted overnight at 250° C. and 20 barg (nominal H₂: 90 cm³ min⁻¹, CO: 50 cm³ min⁻¹), the pressure in the hydrogen cylinder dropped to 20 barg, which caused the H₂ gas flow rate to zero in the reactor over about 12 h. Early in the next morning, after this problem was identified, the H₂ cylinder was replaced. The catalyst bed was then operated under H₂ flow (80 cm³ min⁻¹) at 250° C., 20 barg for 4 h before CO was re-introduced at a flow rate of 50 cm³ min⁻¹ while keeping other reaction conditions constant. Catalyst performance before and after the replacement of H₂ cylinder are shown in the table below. No significant changes in CO conversion or CO conversation rate were observed as shown in Table 11.2.

TABLE 11.2
Performance before and after upset operation without the flow of hydrogen
for 12 h demonstrating robust performance of the inventive FT catalyst.

| | | Total | | | selectivity (%) | | | | | | | | |
|---|---|---|---|---|---|---|---|---|---|---|---|---|---|
| | | flow | Hold | CO conv. | | | Paraffins | | | | | | CO Conv Rate, |
| | T (° C.) | (ml/min) | time (h) | (%) | CO₂ | CH | total | C2-C4 | C5+ | Olefins | Alcohols | H₂/CO | g_{CO}/g_{Cat}/h |
| Before | 250 | 140 | 25 | 57.62 | 0.88 | 7.29 | 95.38 | 4.08 | 84.01 | 2.83 | 0.90 | 1.8 | 19.70 |
| After | 250 | 130 | 4 | 67.87 | 0.44 | 3.98 | 95.98 | 3.14 | 88.86 | 2.75 | 0.83 | 1.6 | 23.20 |

### Example 12. Pellet Vatalyst Stability

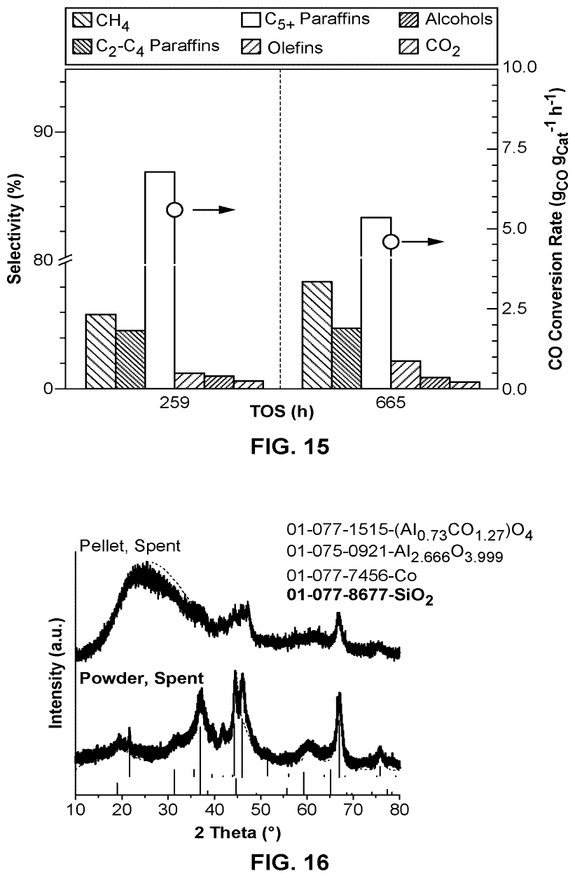

To provide the insight on the pellet catalyst stability, reaction performance at two time on stream (TOS), i.e., 259 h and 665 h, was compared under identical reaction conditions: 225° C., 20 barg, a total gas flow rate of 30 ml/min (STP) with a H₂/CO of 2. This comparison was made after the pellet catalyst was tested at temperatures as high as 260° C. and with a feed H₂/CO ratio as low as 1 between 259 h TOS and 665 h TOS. Further, the catalyst underwent no regeneration as seen in FIG. 15. The CO conversion rate only decreased slightly from 5.61 to 4.57 CO g converted/g_{cat}/h (CO conversion from 82 to 67%) with negligible change in product selectivity, including maintaining <10% CH₄ selectivity.

It is well known that Fischer Tropsch (FT) catalysts show reduced conversion with TOS due to the increase in wax or liquid hydrocarbons condensed within catalyst pores. Typically, the initial reactor operating temperature starts at a low level (e.g., 200-210° C.) and temperature is stepwise increased during a run (e.g., up to 215 to 225° C.) to compensate for slow deactivation thereby extending the duration between catalyst regeneration and or changeout. A traditional FT catalyst is limited in the upper reaction temperature due to thermal runaway or excessive methane formation.

The catalyst performance as shown herein suggests that a commercial FT system operated with this inventive catalyst could begin operation at a higher temperature for higher productivity (e.g., between 210 to 250° C.) and further stepwise increase temperature to compensate for wax deactivation to an even higher temperature, such as 10 to 50° C. higher than the starting temperature without experiencing thermal runaway or excessive methane formation.

These results suggest that the pellet catalyst is stable even at very high temperatures for a Cobalt-based Fischer Tropsch catalyst. Stability results are consistent with characterization data of spent pellet catalysts using TEM, XRD, and Raman as described in Example 13. All techniques show no sign of Cobalt (Co) sintering, the absence of Co₂AlO₄ spinel formation, and significantly less carbon deposition compared to that of spent powder catalyst. Separate SEM analysis also shows no flaking or catalyst coating delamination on pellets.

### Example 13. Powder and Pellet Analysis for Fresh and Spent Catalysts

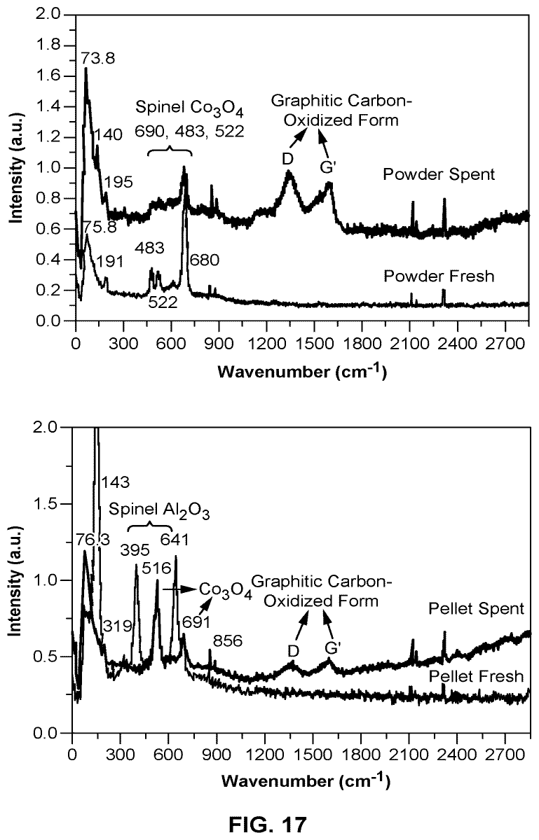

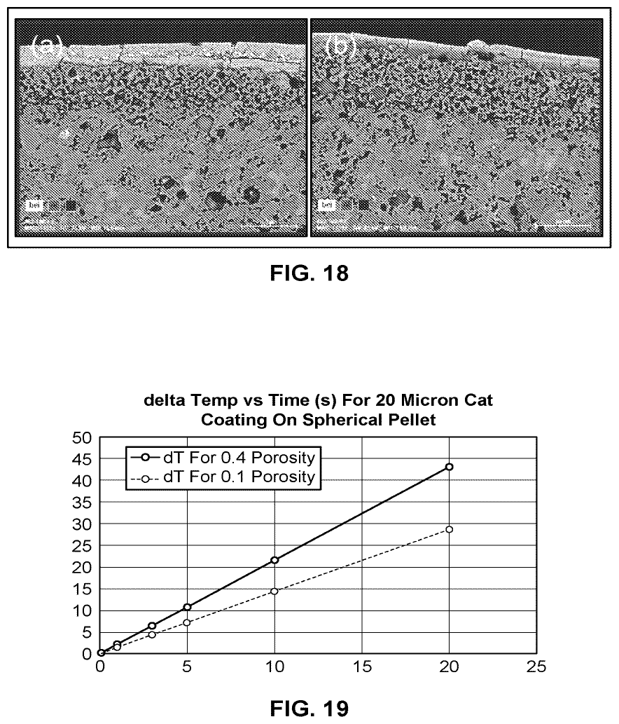

TEM characterization of both fresh and spent powder and pellet catalysts showed no obvious sintering of Co particles (circled), all with the sizes smaller than 20 nm. XRD analysis of both fresh and spent powder and pellet catalysts is shown in FIG. 16. From the XRD diffraction patterns, the spent powder catalyst shows the formation of a Co-aluminate spinel which could lead to dominant CH₄ formation. Compared to spent pellet catalyst, spent powder catalyst has much stronger graphitic carbon peaks, suggesting more severe coke deposition on the spent powder catalyst as compared to the spent coated pellets. Raman analysis of both fresh and spent powder and pellet catalysts is shown in FIG. 17. Compared to spent pellet catalyst, significantly more carbon formation was observed on the spent powder catalyst due to the thermal runaway event. SEM cross-section of fresh and spent FT catalyst is shown in FIG. 18.

### Example 14. Transient Thermal Response of Catalyst Pellet

The catalyst-coated pellet which contains an interlayer with a porosity greater than the pellet core and demonstrates robust performance for transient heat transfer. High catalyst productivity can be achieved without thermal runaway. The lower effective thermal conductivity of the higher porosity interlayer compared to the core creates a larger transient thermal gradient which spreads heat laterally. In effect, the pellet internal temperature is raised more uniformly. The transient temperature rise remains however in control, where the internal temperature rise within the interfacial layer remains less than about 15° C. in about 5 seconds or less which is sufficient time to transfer heat out of the pellet in part into the flowing stream of reactants and products and in part through an array of packed pellets and through a heat transfer wall.

Using a catalyst productivity of 19.7 g CO converted per g_{cat} per hour as measured in example 9 with a coated catalyst density of 4147 kg/m³ and an average coating thickness as measured of about 20 μm results in an average heat flux (q′) of about 2675 W/m². This value is estimated using a heat of reaction of 165 KJ/mol released per mole of CO converted for this highly exothermic reaction. Using unsteady state heat transfer as described by equation 5.62 from the textbook of Bergman and Levine (Fundamentals of Heat Transfer, 8^{th} edition) for a constant heat flux scenario and shown below. The equation is valid for a Fourier number (Fo)<0.2 and underestimates temperature rise for a spherical pellet catalyst.

$$T ( x , t ) - {T}_{i} = \frac{2 {{q}^{′} ( \frac{α t}{π} )}^{1 / 2}}{k} exp ( - \frac{{x}^{2}}{4 α t} ) - \frac{{q}^{′} x}{k} erfc ( \frac{x}{2 \sqrt{α t}} )$$

For a Fo>0.2 and a spherical-pellet shape, the transient quotient q*(Fo) as defined in Table 5.2b from Bergman and Levine is shown below where r is the radius of the catalyst pellet, Fo equals the effective thermal diffusivity multiplied by the transient time and divided by the effective heat transfer distance squared. The heat flux (qs″) is calculated from the reaction heat release per surface area. The thermal conductivity (k) is the effective value for the composite sample. The calculated Ts is the transient temperature at time=t. Ti is the initial temperature. All units are SI.

$${Q}^{*} ( Fo ) = {( 3 Fo + 1 / 5 )}^{- 1}$$

$${q}^{*} = qs ” \times r / ( k \times ( Ts - Ti )$$

Solving for the transient temperature Ts for a spherical particle is shown below.

$$T s = T i + qs ” \times r / ( k \times {q}^{*} )$$

The value of alpha (α) is the thermal diffusivity as defined below where k is thermal conductivity, ρ is density and Cp is specific heat capacity. Effective bed properties for the interfacial layer are used in the transient equation to describe the transient temperature change therein.

$${α}_{e f f} = \frac{{k}_{e f f}}{{( ρ {C}_{p} )}_{e f f}}$$

Effective thermal properties are used where ε is the porosity of the interfacial layer.

$${K}_{e f f} = ε {k}_{f} + ( 1 - ε ) {k}_{s}$$

$${( p {C}_{p} )}_{e f f} = {ε ( ρ {C}_{p} )}_{f} + ( 1 - ε ) {( ρ {C}_{p} )}_{s}$$

A base temperature of 250° C. is used to analyze results as described in example 9 to compare an interlayer with a porosity of 0.4 versus a substantially dense interlayer with a porosity of 0.1.

For a constant heat flux, temperature rises faster for the more porous interlayer as seen in Table 14.1.

TABLE 14.1
Comparison of the transient temperature rise within
the pellet showing the thermal response of a more
porous interlayer (porosity greater than about 0.2).

| | Present | dense |
|---|---|---|
| | invention | interlayer |
| T_initial, C. | 250 | 250 |
| FT Heat flux, W/m2 | 2674.57 | 2674.57 |
| porosity (fraction) | 0.4 | 0.1 |
| base material | alumina | alumina |
| base thermal conductivity, W/m-K | 19.587 | 19.587 |
| base heat capacity, J/kg-K | 1060.79 | 1060.79 |
| base density, kg/m3 | 3900 | 3900 |
| gas thermal conductivity, W/m-K | 0.1436 | 0.1436 |
| gas heat capacity, J/kg-K | 2765 | 2765 |
| gas density, kg/m3 | 4.904 | 4.904 |
| Interfacial layer | | |
| layer thermal conductivity, | 11.81 | 17.64 |
| W/m-K | | |
| layer (den × heat capacity), | 2487662.454 | 3724713.90 |
| J/m3-K | | |
| alpha (thermal diffusivity), m2/s | 4.7473E−06 | 4.7366E−06 |
| transient slab for Fo < 0.2 | | |
| thermal distance, m | 5.00E−05 | 5.00E−05 |
| transient time, s | 1 | 1 |
| function for exponent term | −1.3166E−04 | −1.3195E−04 |
| function for erfc term | 1.1474E−02 | 1.1487E−02 |
| Term 1 | 0.56 | 0.37 |
| Term 2 | 0.0112 | 0.0075 |
| T(x, t) within interfacial layer | 250.546 | 250.365 |
| dT | 0.546 | 0.365 |
| Spherical particle for Fo > 0.2 | | |
| r0, m | 1.50E−03 | 1.50E−03 |
| t, s | 1 | 1 |
| Fo = alpha × t/L\hat{ }2 | 2.11 | 2.11 |
| q* | 1.53E−01 | 1.53E−01 |
| qs″, W/m2 | 2674.57 | 2674.57 |
| k, W/m-K | 11.81 | 17.64 |
| Ti, C. | 250 | 250 |
| Ts (x, t), C. | 252.22 | 251.48 |
| dT, C. | 2.22 | 1.48 |

The pellet transient temperature rises faster with higher porosity as seen in FIG. 19. For the exemplar case from example 9 with the high catalyst productivity, the temperature over 1 second rises around 2.2° C. while the less porous interfacial layer rises only about 1.5° C. A higher temperature in the interfacial layer spreads temperature around the pellet to help raise the overall catalyst temperature and reaction rate. This temperature rise remains in thermal control without creating thermal runaway. There is sufficient time for heat to be removed from the system through gas phase convective heat transfer to the flowing reactant and product mixture and through effective radial conduction through the pellet(s) to the reactor wall where heat is removed from the exothermic reactor system.

### Example 15. Transient Thermal Response with Increased Catalyst Thickness

The catalyst as tested in Examples 6-12 has a measured catalyst thickness of about 20 μm. It is envisioned that thicker catalysts may be advantageous to further increase productivity but not with excessive thickness which would reduce robustness or create reactor thermal runaway.

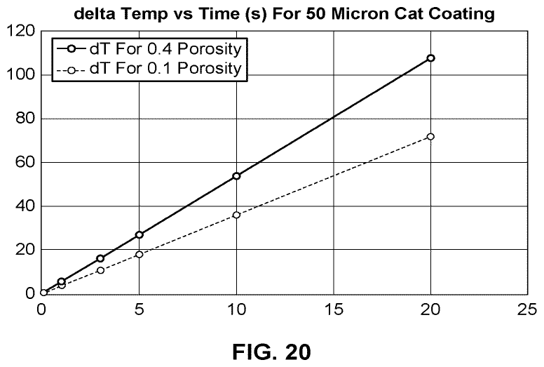

For a comparison case with an estimated 50 μm average catalyst thickness coated on the porous interfacial layer with a catalyst productivity of 19.7 g CO converted per g of catalyst per hour, the expected transient temperature rise is shown in FIG. 20.

The exemplar catalyst system with the more porous interfacial layer will heat more quickly and will be balanced with external heat removal around the pellet to remove the high exothermic reaction heat and maintain thermal control.

### Example 16. Transient Thermal Response for a Conventional Pellet

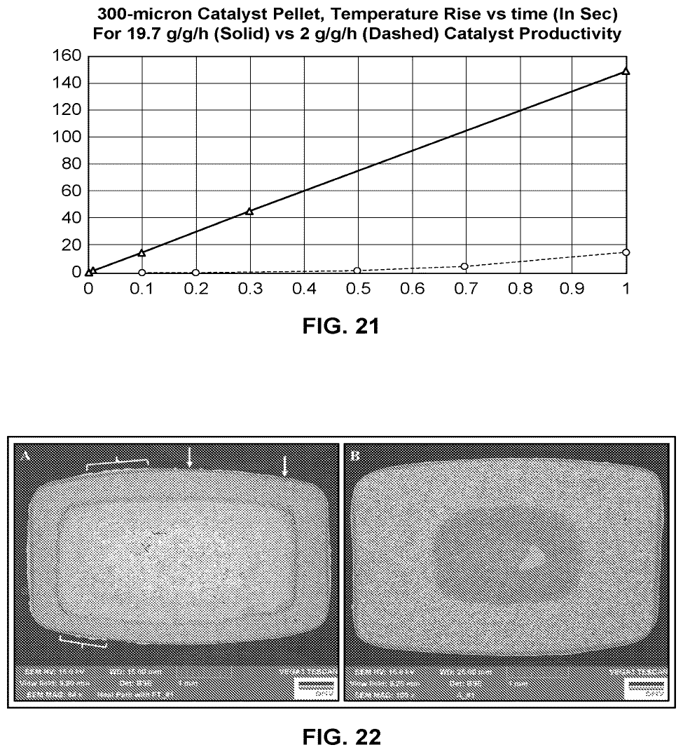

With a comparison conventional pellet catalyst that has an average diameter of 300 μm with active catalyst disposed throughout the pellet and with the same catalyst productivity as measured in Example 9 (19.7 g CO converted per g of catalyst per hour), the predicted transient temperature increase is shown in FIG. 21. The results suggest this pellet would likely experience thermal runaway under conditions in which the inventive catalyst operates productively. A case with a lower catalyst productivity of 2 g CO converted/g_{cat}/h shows that there would likely be sufficient time to remove the reaction heat with a much less active catalyst pellet FT system. This conventional pellet system with lower catalyst productivity is more likely to operate under stable conditions.

The net result shows that the FT system with a highly active coated catalyst on a high thermal conductivity core can achieve stable levels of catalyst productivity that would be unlikely to achieve with a more conventional pellet, even if the pellet were small (greater than about 150 μm or with 300 μm in diameter as shown in FIG. 21). Such a highly active conventional pellet would be unlikely to maintain thermal control at the high productivity rates demonstrated with the inventive FTS coated pellet catalyst even if these small particles were placed inside a highly thermally efficient reactor such as a microchannel or similar configuration. The limiting heat transfer for this high productivity case would be inside the catalyst particle itself. The inventive coated FT catalyst system overcomes this heat transfer limitation and is anticipated to operate with a preferred catalyst coating range from about 10 to about 100 μm with a more preferred range from about 20 to about 50 μm coating thickness on a high thermal conductivity core with a thermal conductivity range from 2 to 50 W/m—K with a more preferred range from 5 to 25 W/m—K.

### Example 17. FT Performance Comparison with Other Catalysts

Fischer Tropsch performance of the coated catalyst as described in Example 9 is compared with the performance of other Fischer Tropsch reactors and catalysts. In Table 17.1 the inventive catalyst is compared to others on a reactor volumetric basis (kg C₅₊ per m³ of reactor volume per hour). The inventive coated pellet catalyst has a higher volumetric productivity than conventional reactors.

TABLE 17.1
Benchmark comparison in kg of
C₅₊ per m³ of reactor volume per hour

| | Volumetric Productivity |
|---|---|
| Comparison | (kg_C5+/m3/h) |
| Ineratec (microchannel) | 1785 |
| Velocys (microchannel) | 1600 |
| Pellet of Example 2 at 250 C. | 505 |
| JM (CANS reactor, Fulcrum planned) | 325 |
| INFRA GTL (Tubular) | 300 |
| Sasol (Slurry) | 200 |
| Nikiski BP (Tubular GTL plant) | 100 |
| Shell Pearl (Tubular) | 100 |

TABLE 17.2
Benchmark comparison in g of CO converted
per gram of catalyst per hour

| Catalyst Productivity | g_CO/g_cat/h |
|---|---|
| Pellet of Example 2 at 250 C. | 19.70 |
| Velocys (microchannel theoretical), 2012 patent | 5.88 |
| Ineratec (microchannel), 2020 paper | 5.80 |
| Velocys (microchannel data), Daly 2016 patent | 4.14 |
| Cao et al 2009, in 1.5 mm diam | 3.14 |
| Powder (same formula as coated on | 0.97 |
| Example 2 Pellet) as tested in 7- | |
| mm diameter tube | |
| Ineratec microchannel, 2019 paper | 0.75 |
| estimated Infra GTL | 0.31 |
| estimated JM CANS FT Reactor | 0.31 |

Comparing catalysts on a basis of g CO converted per gram of catalyst per hour as seen in Table 17.2 shows that the inventive FT catalyst is substantially better than the prior art. The catalyst activity on a per gram of catalyst for the exemplar case outperforms even the microchannel FT catalysts by a substantial margin. The catalyst productivity for the inventive catalyst of 19.7 g/g/h is more than 3 times higher than the best results published by Ineratec (2020) and the highest theoretical case (Daly et al, WO 2012/107718).

Data comparing reported FT catalysts for a basis of gram of C₅₊ hydrocarbon produced per gram of Co per hour in Table 17.3.

TABLE 17.3
Benchmark comparison in g of
C₅₊ produced per gram of Co per hour

| Catalyst Productivity | g_C5+/g_Co/h |
|---|---|
| Pellet of Example 2 at 250 C. | 58.5 |
| Ineratec (microchannel), 2020 paper | 24.7 |
| Velocys (microchannel theoretical), Daly patent 2012 | 12.6 |
| Velocys (microchannel data), Daly 2016 patent | 8.7 |
| Cao et al 2009, in 1.5 mm diam | 5.58 |
| Powder (same formula as coated on | 2.85 |
| Example 2 Pellet) as tested in 7- | |
| mm diameter tube | |
| estimated JM CANS Reactor | 2.5 |
| estimated Infra GTL | 1.3 |

Each of the prior art catalysts had differing amounts of cobalt in the formula, and normalized on the per gram of Cobalt, the inventive catalyst is substantially higher. Published catalyst productivity in comparison with the present invention is shown in Table 17.4.

TABLE 17.4
Benchmark comparison in g of hydrocarbons HC
(C₅₊) produced per gram of catalyst per hour

| Catalyst Productivity | g_HC/g_cat/h |
|---|---|
| Pellet of Example 2 at 250 C. | 17.73 |
| Velocys (microchannel theoretical), Daly patent 2012 | 5.29 |
| Ineratec (microchannel), 2020 paper | 4.93 |
| Velocys (microchannel data), Daly 2016 patent | 3.63 |
| Cao et al 2009, in 1.5 mm diam | 1.69 |
| Velocys, pilot, Leviness 2013 | 1.21 |
| Powder (same formula as coated on | 0.67 |
| Example 2 Pellet) as tested in 7- | |
| mm diameter tube | |
| estimated Infra GTL | 0.25 |
| estimated JM CANS FT Reactor | 0.25 |

### Example 18. Improvement of Catalyst Coating Using Glycerol and Polyvinyl Alcohol (PVA) Solution vs. Pure Aqueous Solution

The catalyst coating process was modified to further improve coating uniformity and catalytic performance for the Fischer Tropsch reaction. The new method #2 creates an improved coating quality with improved uniformity of coating thickness and fewer regions with coating gaps around the pellet circumference for a more complete surface coverage. The net result of the second coating method is improved FT synthesis performance where the produced hydrocarbons as denoted by the calculated alpha value ranges from about 0.88 to 0.94 as compared to less than about 0.84 with method #1 coating as used in the previous examples.

### Materials and Chemicals

γ-Alumina support (98% Al₂O₃, PURALOX®TH 100/150 L4) was obtained from Sasol. Co(NO₃)₂·6 H₂O (98%) and perrhenic acid solution (HO₄Re, 75-80 wt % in H₂O) were purchased from Sigma-Aldrich and used as received. Pellets were core materials as described in Example 1 using the Case 2 synthesis protocol.
Catalyst synthesis: 30 wt % Co/4.5 wt % Re/γ-Al₂O₃ catalyst was synthesized using incipient wetness impregnation method. The Al₂O₃ support was pre-calcined at 500° C. in air for 2 h and stored in a desiccator. Then, 46 g Co(NO₃)₂-6 H₂O and 1.1 mL HO₄Re solution were dissolved in 22 mL H₂O as a stock solution. 8 mL stock solution was added to 20 g pre-calcined Al₂O₃ support via an incipient wetness impregnation method, followed by drying at 90° C. for 8 h and a calcination at 350° C. for 3 h in air. The same procedure was repeated twice with 7 mL stock solution added to the solid mixture each time until all of the stock solution was added. The obtained powder weighed ˜35 g and was denoted as Co—Re/Al₂O₃ for further preparation of the catalyst. The loading ratio of Co and Re were estimated to be 30.3 wt %, and 4.8wt %, respectively.
Coating Method #1: dip-coating procedure of catalysts slurry on pellets using water-based slurry. To prepare the catalyst slurry, 3 g Co—Re/Al₂O₃ catalyst was ball-milled with 17 mL water for 3 h. Pellets (typically 5-10 pellets at once) were then dip-coated in the slurry and dried at 80° C. to create a thin coating. The dip-coating followed by drying process was repeated by ˜6 times to obtain a catalyst coating of ˜2.5 mg on each pellet. The pellets were then calcined at 550° C. for 4 h in air with a ramp rate of 5° C./min.
Coating Method #2 of dip-coating procedure of catalysts slurry on pellets using a glycerol and PVA-based slurry: 2.5 g Co—Re/Al₂O₃ catalyst was ball-milled with 0.12 g PVA in 16 mL 40 wt % glycerol solution for 4 h to prepare the catalyst slurry. Typically, 100 pellets were dip-coated in the catalyst slurry at 80° C. to create a thin coating. The dip-coating followed by drying process was repeated by ˜3 times to obtain a catalyst coating of ˜2.5 mg on each pellet. The pellets were then calcined at 550° C. for 4 h in air with a ramp rate of 5° C./min.

### Catalytic Evaluation:

The Fischer-Tropsch (FT) reactions were conducted out as described in Example 3. The activation of the catalyst was conducted in a tube furnace with two redox cycles, each of which consisted of two steps: the first step reduced the catalyst with 10% H₂ in N₂ at 1 bar (50 cm³min⁻¹). The temperature was programmed as follows: from room temperature to 250° C. with 0.5° C./min, and held 30 min, then increased to 400° C. at 0.5° C./min and held for 10 h. N₂ was subsequently introduced while cooling down to room temperature. The second step oxidized the catalyst with 1% O₂ in N₂ at 1 bar (50 cm³ min⁻¹). The reactor was heated at a rate of 2° C./min up to 350° C. kept by 2 h. The reactor was then cooled to room temperatures in flowing N₂.

After the above two steps were repeated to fulfill two redox cycles, the catalysts were transferred to the isothermal region of the reactor, and the final reduction was carried out in-situ with H₂ at 1 bar (25 cm³min⁻¹) up to 400° C. for 12 h, at a rate of 0.5° C./min. After that, the temperature ramped down to 160° C. and the total pressure was raised to 20 barg with H₂ and switched to the H₂ and CO mixture. The synthesis temperature was reached with a heating rate of 0.1° C. min/min. Catalytic activity and product selectivity data were taken at least 12 h TOS after a change in conditions after the initial stabilization phase of more than 100 hours when the system reached steady state using chromatography-mass spectrometry equipped with two sampling loops (GC-MS, Agilent 7890A-5975). The GC-MS system and the outlet of the reactor were connected through a capillary which was maintained at 200° C. by a heating tape for avoiding condensation of heavy products. Light gases (up to C₃) were determined by a thermal conductivity detector (TCD) with two connected columns of 3 Foot and 9 Foot Hayesep Q 80/100 (in backflush mode), while C₄₊ hydrocarbons and alcohols were analyzed by an MS detector and the DB-1 capillary column. The conversion of CO was calculated from the sum of all carbon products and the carbon balance as described in Example 5.

### RESULTS AND DISCUSSIONS

The SEM images in FIG. 22 showed that Coating Method #2 resulted in much more uniform coating compared to Coating Method #1. Method #1 used a water-based slurry that led to the formation of “islands” in the coated catalyst layer as indicated by the brackets and uncoated surface of pellets as indicated by arrows in FIG. 22 (A). The cross-section SEM image overlapped with EDX elemental mapping showed that the catalyst coating obtained from Method #2 has improved the coating uniformity with a coating thickness range from about 15 to 23 μm as narrowed from a thickness range of about 5.6 to 37 microns for Method #1 as shown in Table 18.1.

TABLE 18.1
Comparison of Quality by Coating Method
Coating Uniformity and Thickness Comparison

| | Average | Standard | | |
|---|---|---|---|---|
| Coating | Thickness | Deviation | Maximum | Minimum |
| Method | (μm) | (μm) | (μm) | (μm) |
| Method #1 | 18.57 | 10.07 | 36.73 | 5.62 |
| Method #2 | 18.74 | 2.94 | 22.55 | 15.18 |

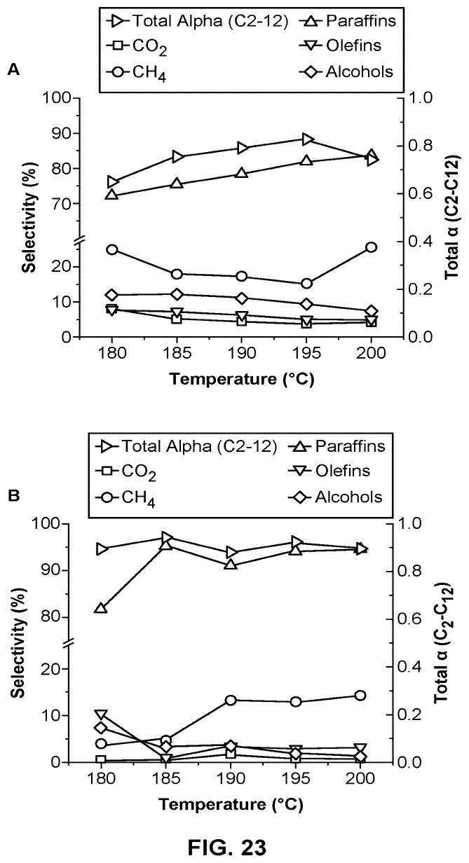

As shown in FIG. 23, the more uniformly coated-pellets obtained from Method #2 resulted in higher total alpha values of C₂-C₁₂ products under similar condition at temperatures from 180 to 200° C. Pellets from coating Method #1 showed alpha values ranging from 0.65 to 0.83, while pellets from coating Method #2 showed alpha values ranging from 0.88 to 0.94. Additionally, pellets from Method #2 showed much improved C₂-C₁₂ paraffin selectivity compared the counterpart from Method #1, due to suppressed CO₂ selectivity (<1.8%) and CH₄ selectivity (<14.3%) across the full temperature range tested. C₂-C₁₂ Olefin and alcohol selectivity on pellets from Method #2 are also generally lower than those on pellets from Method #1. These results show that a more uniformly coated catalyst layer on pellets significantly improved the more selective production of C₂-C₁₂ paraffins compared to a non-uniformly coated catalyst layer.

The conversion of CO for the test conditions and flowrates after a total of 100 h operation and with at least 12 h at each condition is shown in Table 18.2. The total catalyst coated was 108 mg of active material comprising Co, Re, and support material as coated on the pellet core and tested in the 4.04 cm³ reactor volume as described in previous examples.

TABLE 18.2
CO conversion for FT synthesis on the catalyst-coated
pellets at the specified total flowrate as tested with a 2:1
H₂/CO feed ratio for the exemplar catalyst produced
with Method #2 at 20 barg reactor pressure.

| Temperature in ° C. | CO Conversion % | Total Flow, sccm |
|---|---|---|
| 190 | 11.7 | 15 |
| 195 | 18.1 | 15 |
| 200 | 19.9 | 30 |

### Example 19. Reduced FT Synthesis Operating Pressure

It is generally known that the operating pressure should be at least about 20 barg to obtain quality performance for a Fischer Tropsch catalyst. It is desirable to operate an FT synthesis reactor at lower pressure to match with a SMR or DRM front-end process for synthesis gas production where reduced front-end pressure allows for a higher equilibrium conversion. In an ideal process, the pressure is sufficient to operate without interstage compression between the front-end DRM/SMR and the FT synthesis. Further, it is desirable to operate the FT synthesis with 2-stages, where water and liquids are condensed between a first and second FT stage. The pressure of the second stage FT synthesis would preferably be lower than the first stage FT synthesis reactor to avoid an additional boost compressor. In this case, the overall carbon efficiency for conversion of CH₄ and/or CO₂ to C₅₊ hydrocarbons produced in an FT synthesis process is greater than 60% and more preferably greater than 65% and more preferably still greater than 70% and may range from about 60% to 90%.

In a conventional FT synthesis fixed bed catalyst, the catalyst is poorly conductive, and the internal catalyst site temperature is higher than the recorded wall or gas temperature by up to tens of degrees C. The inventive highly conductive catalyst generates a lower exotherm and results in a lower catalyst temperature. With the reduced local temperature resulting from the inventive FT catalyst coated on the highly conductive pellet, the liquid film as formed in the catalyst pores is anticipated to remain stable at a lower pressure than expected from a traditional catalyst pellet.

From the results of the exemplar catalyst, a product composition was calculated based on a feed syngas ratio of 2:1 without diluent for a CO conversion of 61.3%, a methane selectivity of 10.3%, a C₂ selectivity of 2.7%, a C₃ selectivity of 1.4%, and a C₅₊ hydrocarbon selectivity of 7.6%. The remaining C₅₊ selectivity is 76.6% and remaining carbonaceous species are CO₂ or other trace amounts of alcohols and aldehydes. The fraction of C₅₊ produced was adjusted into estimated carbon species from C₅ to C₃₀ using alpha as determined with an Anderson-Schulz-Flory (ASF) distribution. The resultant composition was analyzed using a VLE flash calculation to assess the fraction of liquid remaining as a function of reactor temperature and pressure.

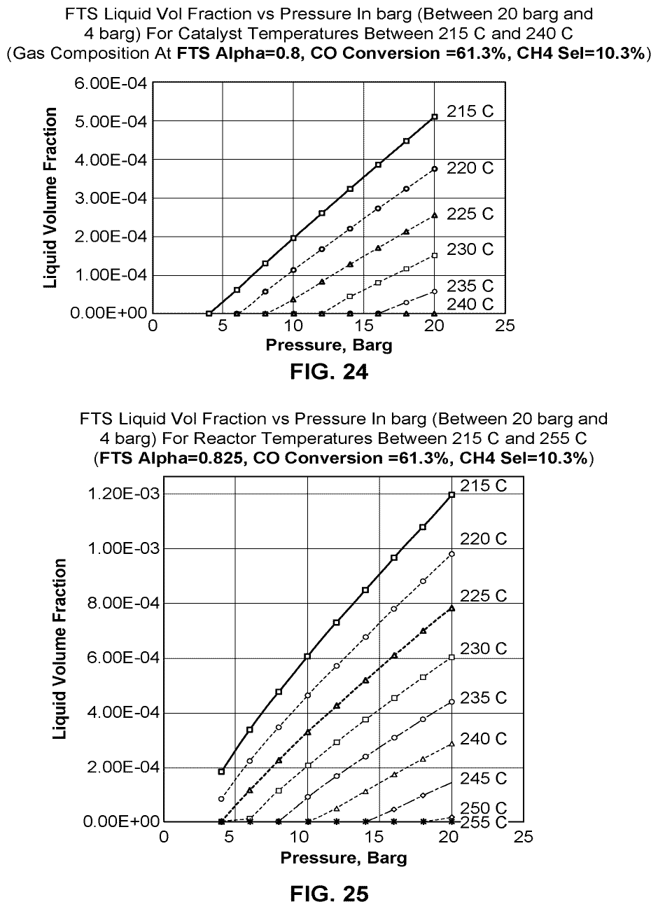

In FIG. 24, a representative alpha of 0.8 the liquid volume fraction is predicted from 4 to 20 barg for a temperature from 215 to 240° C. For a catalyst that operates with an alpha of 0.8 at 230° C., it is anticipated that the operating pressure could be reduced from 20 barg to about 16 barg for the inventive catalyst.

In FIG. 25, a representative alpha of 0.825 the liquid volume fraction is predicted from 4 to 20 barg for a temperature from 215 to 255° C. For the inventive catalyst that operates with an alpha of 0.825 at 230° C., it is anticipated that the operating pressure could be reduced from 20 barg to about 8 barg for the inventive catalyst while still obtaining excellent results.

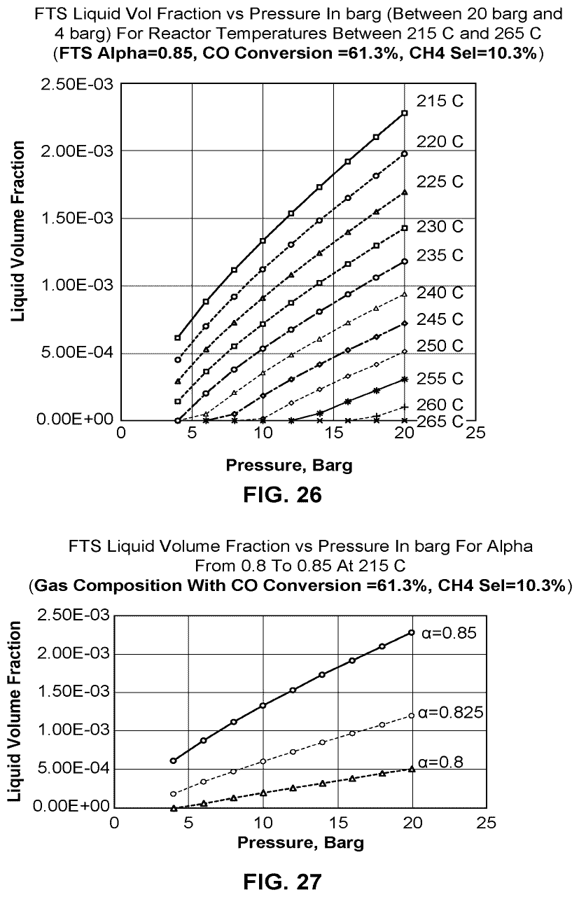

In FIG. 26, a representative alpha of 0.85 the liquid volume fraction is predicted from 4 to 20 barg for a temperature from 215 to 265° C. For the inventive catalyst that operates with an alpha of 0.85 at 230° C., it is anticipated that the operating pressure could be reduced from 20 barg to about 4 barg.

FIG. 27 shows the effect of alpha on the retained liquid fraction at 215° C. versus pressure in barg for alpha from 0.8 to 0.85. The higher the alpha, the greater the reduction in pressure is anticipated to retain a stable liquid film as enabled by the inventive catalyst structure.

The results in Example 9 showed that the measured experimental alpha level was 0.806 at 255° C., 0.816 at 245° C., and 0.838 at 240° C. for the reactor as operated at a pressure of 20 barg. The high values of alpha at the elevated temperature suggest that the pressure could be further reduced with a greater reduction anticipated for higher values of alpha.

The modified catalyst coating protocol as described in Example 18 shows an alpha up to about 0.94. It is anticipated that a coated FT synthesis catalyst operating with a high alpha level should be able to operate with a lower operating pressure. The reduced operating FT pressure could enable a once-through process for DRM and or SMR to produce synthesis gas followed by one or two stages of FT synthesis in series. Alternatively, the FT synthesis and or SMR/DRM process using the inventive catalyst may be operated in a recycle mode which also may alternatively include interstage separation and heat exchange.

The FT synthesis catalyst made using the Method #2 coating process is anticipated to operate with a temperature as high as about 280° C. resulting from the higher process alpha. The operating pressure is anticipated to be reduced to as low as 6 barg. It is further anticipated that the pressure can be more reduced for lower temperatures and operated in a stable manner if there is a sufficient liquid film retained on the surface of the catalyst when the liquid volume fraction is greater than about 1×10−5 under FT synthesis reaction conditions.

### Example 20. Activity Test

A performance test to measure the catalyst productivity in g/g/h should be conducted using an FT synthesis catalyst comprising cobalt. The catalyst in a pellet form is packed within a tubular reactor with sufficient heat removal along the reactor length as achieved by either partial boiling of water where the mass fraction of water to undergo phase change is maintained below a maximum of about 10% or through convective flow of a hot oil or heat transfer fluid where the velocity of the oil is greater than about 1 m/s. The catalyst pellets are well-packed with about 3 average particle diameters per tube diameter. The tube for testing should accommodate about 1 gram of active catalyst as measured by the cobalt or other metals and the high surface area support material upon which the active catalyst is disposed. Prior to operating, the catalyst is reduced using multiple alternating reduction and oxidation steps as described below.

The activation of the catalyst is conducted in a tube furnace with two redox cycles, cach of which consisted of two steps: the first step reduces the catalyst with 10% H₂ in N₂ at 1 bar (0.5 L min⁻¹ per gram of catalyst). The temperature is programmed as follows: from room temperature to 250° C. with 0.5° C./min, and hold for 30 min, then increase to 400° C. with 0.5° C./min and hold for 10 h. N₂ is introduced during cool down to room temperature. The second step oxidizes the catalyst with 1% O₂ in N₂ at 1 bar (0.5 L min⁻¹ per gram of catalyst). The reactor is heated at a rate of 2° C./min up to 350° C. and hold for 2 h. The reactor is then cooled to room temperature by flowing N₂ at least at 1 Liter per min. After the above two steps are repeated to complete two redox cycles, the catalysts are transferred to the isothermal region of the reactor, and the final reduction is carried out in-situ with H₂ at 1 bar (0.25 L min⁻¹ per gram of catalyst) up to 400° C. for 12 h, at a rate of 0.5° C./min.

After the final reduction step, the temperature is ramped down to 160° C. and the total pressure is raised to 20 barg with H₂ before swapping with a H₂ and CO synthesis gas mixture with a 2:1 feed ratio. The start-up flowrate of synthesis gas should be about 18 L/h/gram of catalyst. The temperature is raised to 180° C. from 160° C. at a rate of 0.5° C./min and held for 100 h. The temperature is raised by 5° C. at the same rate and held for an additional 24 h repeatedly until the temperature reaches 210° C. and the CO conversion is measured. After start-up, the catalyst performance is slowly increased in an iterative manner. After each change of either flowrate or temperature, the reactor is held for 24 h to stabilize performance.

If the CO conversion is less than 30% then temperature is raised in 5° C. increments at 0.5° C./min and held for 24 h until the conversion has surpassed 30% but not more than 60%. When conversion is greater than 30%, the total gas flow is doubled, that is from 18 to 36 L/h/g_{cat}. The temperature is raised by 5° C. at the same rate of 0.5° C./min and held for 24 h until the conversion is again greater than 30% but not more than 60%. This iteration is continued where the total gas flowrate is increased in 20-50% increments until at least 300 L/h/gram catalyst. Temperature is increased until at least 240° C. and the catalyst productivity in g of CO converted to C₅₊ per hour per gram of catalyst exceeds at least 2. Further increases in temperature and gas flowrate are maintained such that the catalyst productivity is from about 2 to 30 g/g/h. When the CO conversion exceeds 30%, the subsequent temperature increases should be limited to about 2° C. followed by a hold for 24 h. The measured methane selectivity will be less than about 15%. The catalyst productivity should be measured when the CO conversion is at least about 60% and less than about 80%.

Liquid is collected when the catalyst is operating with a productivity of at least 2 g/g/h and analyzed using a high temperature distillation column for FTS. The liquid hydrocarbon alpha is calculated from the hydrocarbon distribution data as described in Example 5 and alpha is above 0.8, methane selectivity is less than 15% for the high productivity catalyst.

### REFERENCES

Altalto Project 2020, https://www.velocys.com/projects/altalto/.
Cao et al., 2009, Intensified Fischer-Tropsch Synthesis Process with Microchannel Catalytic Rectors, Catalysis Today, 140 (3-4), 149-156.
Daly et al., 2012, Fischer-Tropsch Catalysts and Method of Preparation Thereof, WO 2012/107718.
Daly et al., 2016, US 2016/0304789.
Desmukh, et al., 2016, Commercializing an Advanced Fischer-Tropsch Synthesis Technology: Advances and Applications, in Fischer-Tropsch Synthesis, Catalysts and Catalysis, 361-378.
Dittmeyer, R., Synthetic Fuels from Carbon Dioxide and Renewable Electrical Energy (e-fuels) enabled by Compact Microchannel Reactors, 9^{th} International Freiberg Conference IGCC/XTL Technologies Berlin, Jun. 4-8, 2018.
Ermolaev, et al., 2013, U.S. Pat. No. 8,525,787.
Fulcrum Bioenergy, 2020, Sierra Biofuels Plant, https://fulcrum-bioenergy.com/facilities/.
Glebova, O., 2013, Gas To Liquids: Historical Development and Future Prospects, The Oxford Institute for Energy Studies, https://www.oxfordenergy.org/wpcms/wp-content/uploads/2013/12/NG-802.pdf.
Ineratec GMBH, Compact Fischer-Tropsch Synthesis In Gas-To-Liquid Applications, 2^{nd} COMSYN workshoe-Future of BTL products in Europe, Prague and Litvinov, Czech Republic, May 23-23, 2019.
Ineratec, Power-to-Liquid Pioneer Plant 2022, https://ineratec.de/en/power-to-liquid-pioneer-plant-2022/.
Le Viness, et al., 2013, Velocys Fischer-Tropsch Synthesis Technology—New Advances on State-of-the-Art, Topics in Catalysis, 57 (6-9): 518-525.
Loewert, et al., 2019, Microstructured Fischer-Tropsch Reactor Scale-up and Opportunities for Decentralized Application, Chemical Engineering & Technology, doi: 10.1002/ceat.201900136
Loewert, et al., 2020, Dynamically Operated Fischer-Tropsch Synthesis in PtL-Part 1: System Response on Intermittent Feed, Chem Engineering 4(2), 21.
Loewert, et al., 2020, Dynamically Operated Fischer-Tropsch Synthesis in PtL-Part 2: Coping with Real PV Profiles, Chem Engineering 4(2), 27.
Mordkovich, et al., 2012, Support for Catalyst of Exothermic Processes and Catalyst Prepared Theron, US 2012/0122674 A1.
Oxford Catalysts, 2008,
https://www.velocys.com/arcv/financial/other/re_admission_document_3nov08.pdf
Peacock, et al., 2020, Innovation in Fischer-Tropsch: Developing Fundamental Understanding to Support Commercial Opportunities, Topics in Catalysis, 63, 328-339.

What is claimed:

1. A catalyst support, comprising three distinct layers:
and comprising:
a core comprising Al, Si, C, and O;
a first layer adjacent to the core, comprising Al and Si, C and O;
a second layer adjacent the first layer comprising Al, Si, C and O;
wherein the first layer has greater porosity than the second layer and wherein the concentration of O in the core is at least 2.5 wt % less O than the first layer; or
a core comprising Si, C, Al, and O, and comprising at least 2 vol % of a metallic Al alloy;
a first layer adjacent the core comprising Si, C, Al, and O, and comprising no more than 1 vol % of a metallic phase (preferably no discernable metallic phase);
a second layer adjacent the first layer comprising Si, C, Al, and O and comprising no more than 1 vol % of a metallic phase (preferably no discernable metallic phase);
wherein the first layer has greater porosity than the second layer and wherein the concentration of O in the core is at least 2.5 wt % less O than the first layer.

2. The catalyst support of claim 1 further comprising an outer protective layer of Al and O disposed outside the second layer; wherein the protective alumina layer is at least 20% more porous than the second layer of the core.

3. A Fischer-Tropsch catalyst comprising the support of claim 2 wherein Co metal particles dispersed on an oxide powder are disposed on a layer deposited on the outer protective layer of Al and O. This structure can be obtained by depositing the Co catalyst layer as a slurry over the outer protective layer.

4. The catalyst of claim 1 wherein an outer layer of aluminum is spray coated on the exterior of the support, which can be subsequently oxidized to produce an alumina layer.

5. The catalyst support of any of the above claims wherein the core, first layer and second layer each comprise SiC and Al₂O₃.

6. The catalyst support of any of the above claims characterizable by a thermal expansion of 1.0% or less (or 0.50% or less or 0.25% or less) when measured according to the conditions corresponding to the data in Table 1.6.2.

7. A method of conducting the Fischer-Tropsch reaction, comprising:
passing a gaseous mixture of CO and H₂ over a thermally-conductive catalyst at a temperature of at least 200° C.;
wherein the thermally conductive catalyst comprises Co metal disposed on the outside of a catalyst pellet comprising a core comprising Al, Si, C and O having a first porosity and an outer protective alloy-derived coating layer surrounding and adjacent to the core; wherein the alloy-derived coating has a higher porosity than the core; wherein the alloy-derived coating is disposed between the core and the Co metal.

8. The method of claim 7 wherein the thermally-conductive catalyst comprises a bed of pellets disposed in a reactor having an inner diameter of at least 0.7 cm, preferably at least 5 cm.

9. The method of claim 7 or 8 wherein the Co metal comprises Co and Re.

10. The method of claim 7 wherein the reacting mixture comprising gas and liquid travels downward with respect to gravity through the particle bed.

11. The method of any of the above method claims comprises an outer catalyst layer comprising the Co metal in the form of metal particles disposed on a porous alumina layer wherein the outer catalyst layer has a thickness of between 10 and 100 μm or between 20 and 50 μm.

12. The method of any of the above method claims wherein the core and alloy coating layer define a core pellet and wherein the core pellet has a thermal conductivity between 2 and 50 W/m—K or between 5 and 20 W/m—K.

13. The method of any of the above method claims wherein the temperature has a high temperature in the range of 210 to 280° C., or 240 to 280, or 260 to 280.

14. The method of any of the above method claims wherein the feed ratio of H₂:CO is in the range of 1:2 to 3:1 or 1.6 to 2.0.

15. The method of any of the above method claims wherein the gaseous mixture is pretreated to remove sulfur and/or ammonia to ≤1 ppm.

16. The method of any of the above method claims wherein the partial pressure of steam in a reacting mixture is maintained at 6 barg or less.

17. The method of any of the above method claims wherein pressure in the reactor is in the range of 10 to 40 barg, or at least 20 barg

18. The method of any of the above method claims wherein the reaction is run 500 h without regeneration; or regenerated every 1000 or 2000 h.

19. The method of any of the above method claims wherein the reaction is run at 240° C. or higher and wax is produced.

20. The method of any of the above method claims wherein methane selectivity is 15% or less or 10% or less.

21. A pellet comprising central region comprising the 10 wt % of the pellet that is furthest from a surface and comprises aluminum oxide, aluminum alloy and SiC, and an outer alumina region comprising 10 wt % of the pellet corresponding to the volume of the pellet that is furthest from the central region; and wherein the outer alumina region comprises aluminum oxide, SiC;
and wherein the outer alumina region comprises at least 5% higher oxygen concentration as compared to the central region.

22. The pellet of claim 21 wherein the central and outer alumina regions define part of a catalyst support and further comprising a catalyst layer disposed on an exterior of the pellet.

23. The pellet of any of claims 21-22 comprising a FT synthesis catalyst coating and characterizable by a conversion of at least 5, or at least 10, or at least 12, or at least 15 g of CO converted per gram of catalyst per hour with a methane selectivity ≤15%, ≤10%, ≤8%, or ≤6%; wherein the characterization is conducted using catalyst pellets packed in a tube with about 3 average pellet diameters per tube inner diameter and a total of about 1 gram of active catalyst, heating to 240° C. and passing H₂ and CO in a molar ratio of 2:1 through the catalyst at a rate set to a CO conversion of between 60 and 80%.

24. The pellet of any of claims 21-23 comprising a FT synthesis catalyst coating and characterizable by an alpha greater than 0.8, preferably greater than 0.84 and more preferably from 0.85 to 0.95; wherein the characterization is conducted using catalyst pellets packed in a tube with about 3 average pellet diameters per tube inner diameter and a total of about 1 gram of active catalyst, heating to 240° C. and passing H₂ and CO in a molar ratio of 2:1 through the catalyst at a rate set to a CO conversion of between 60 and 80%.

25. The pellet of any of claims 21-24 having a hydraulic diameter from 1 to 10 mm.

26. A method of making a catalyst, comprising:
providing a catalyst core of claim 1;
coating the core with a slurry comprising: Co or Re; an organic binder, and a plasticizer.

27. The method of claim 26 wherein the organic binder is selected from the group consisting of:
polyvinyl alcohol, methyl cellulose, ethyl cellulose, starch, gums, polyvinyl butyral, and combinations thereof.

28. The method of claim 26 or 27 wherein the plasticizer is selected from the group consisting of: glycerol, Glycerin, Ethylene Glycol, Polyethylene Glycol, and combinations thereof.
